(19) United States
(12) Patent Application Publication
(10) Pub. No.: US 2023/0303881 A1
(43) Pub. Date: Sep. 28, 2023

(54) INKJET FLUID SET

(71) Applicant: HEWLETT-PACKARD DEVELOPMENT COMPANY, L.P., Spring, TX (US)

(72) Inventors: Jie Zheng, San Diego, CA (US); Dennis Z. Guo, San Diego, CA (US)

(21) Appl. No.: 17/705,093

(22) Filed: Mar. 25, 2022

(51) Int. Cl. C09D 11/54; C09D 11/102; C09D 11/106; C09D 11/033; C09D 11/037; C09D 11/38; D06P 5/30; B41J 11/00

(52) U.S. Cl. CPC C09D 11/54; C09D 11/102; C09D 11/106; C09D 11/033; C09D 11/037; C09D 11/38; D06P 5/30; B41J 11/002

(57) ABSTRACT

An inkjet fluid set includes a colorless pre-treatment fluid, a colorless fixer fluid, and a white inkjet ink. The colorless pre-treatment fluid includes a first polymeric binder selected from the group consisting of an acrylic copolymer, an acrylamide copolymer, a polyester-polyurethane, and a polyether-polyurethane and a pre-treatment vehicle. The colorless fixer fluid includes a cationic polymer and a fixer vehicle. The white inkjet ink includes a white pigment, a second polymeric binder, and an ink vehicle.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration of an example of an inkjet fluid set and an example of a textile printing kit, each of which includes an example of a colorless pre-treatment fluid, an example of a colorless fixer fluid, and an example of a white inkjet ink;

FIG. 2 is a schematic diagram of an example of a printing system and different examples of the printing method;

FIG. 3A and FIG. 3B are black and white reproductions of originally colored photographs of a comparative print before and after washing cycles;

FIG. 4A and FIG. 4B are black and white reproductions of originally colored photographs of an example print before and after washing cycles;

FIG. 5A and FIG. 5B are black and white reproductions of originally colored photographs of an example print before and after washing cycles;

FIG. 6A and FIG. 6B are black and white reproductions of originally colored photographs of another comparative print before and after washing cycles;

FIG. 7A and FIG. 7B are black and white reproductions of originally colored photographs of another example print before and after washing cycles;

FIG. 8A and FIG. 8B are black and white reproductions of originally colored photographs of yet another example print before and after washing cycles;

FIG. 9A and FIG. 9B are black and white reproductions of originally colored photographs of still another example print before and after washing cycles;

FIG. 10A and FIG. 10B are black and white reproductions of originally colored photographs of another comparative print before and after washing cycles;

FIG. 11A and FIG. 11B are black and white reproductions of originally colored photographs of another example print before and after washing cycles; and

FIG. 12 is a photograph, reproduced in black and white, of the backside of a fabric illustrating the strikethrough of a comparative print (Print 30, the outline of which is represented by a dashed line) and the reduction of strikethrough of an example print (Print 29, the outline of which is also represented by a dashed line).

### DETAILED DESCRIPTION

The textile industry is a major industry, and printing on textiles, such as cotton, polyester, etc., has been evolving to include digital printing methods. Some digital printing methods enable direct to garment (or other textile) printing. White ink is one of the most heavily used inks in direct to garment printing. More than two-thirds of the direct to garment printing that is performed utilizes a white ink on a colored textile. Obtaining white images with desirable opacity has proven to be challenging, in part because different textile fabrics introduce different obstacles that can affect the white print. As an example, cotton fabrics are more likely than polyester fabrics to have fibrillation (e.g., hair-like fibers sticking out of the fabric surface).

Pre-treatment fluids have been developed to address fibrillation. However, most, if not all, of these pre-treatment fluids are applied using analog methods, such as spray or roll on techniques. With analog application methods, the pre-treatment fluid is coated on the entire textile fabric. As such, the pre-treatment fluid may be applied onto an area that is larger than the image that is ultimately formed. This process can waste pre-treatment fluid. Moreover, analog application methods are often performed outside of the printer using separate equipment for pre-treatment.

Disclosed herein is an inkjet fluid set that is particularly suitable for obtaining white images, which may have desirable opacity, durability (i.e., washfastness), and quality. Examples of the inkjet fluid set include a pre-treatment fluid, a fixer fluid, and a white inkjet ink. Each of the fluids and the ink are jettable via a piezoelectric or a thermal inkjet printer, which eliminates the need for additional equipment for pre-treating the textile fabric. The pre-treatment fluid includes a binder, which intermingles with the positively charged cationic polymer in the fixer fluid to form a mixed fluid layer on the textile fabric. This mixed layer has an increased viscosity relative to the individual fluids, which blocks at least some pores of the textile fabric. As a result, more of the cationic polymer in the fixer fluid is retained at the surface of the textile fabric for interaction with the pigment of the white inkjet ink. This allows the pigment to be fixed at or near the surface of the textile fabric, which improves the opacity of the white image that is formed. Moreover, the mixed fluid layer may be able to hold the hair-like fibers of the textile fabric, which reduces fibrillation and improves image quality.

The opacity may be measured in terms of L*, i.e., lightness, of a white print generated on a colored textile fabric. A greater L* value indicates a greater opacity of the white ink on the colored textile fabric. L* is measured in the CIELAB color space, and may be measured using any suitable color measurement instrument (such as those available from HunterLab or X-Rite). The white inkjet ink, when printed on the colored textile fabric pre-treated with the pre-treatment fluid and the fixer fluid disclosed herein, may generate prints that have a desirable L* value.

The durability of a print on a textile fabric may be assessed by its ability to retain color after being exposed to washing. This is also known as washfastness. Washfastness can be measured in terms of a change in L* before and after washing.

The fluid(s) and/or white inkjet ink disclosed herein may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of a polyurethane-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the Mutek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

Throughout this disclosure, the term “colorless” means a fluid that is devoid of a colorant (e.g., a pigment or dye). The colorless fluid may exhibit a tint, e.g., due to the other components, such as polymeric binder, contained therein.

The term “molecular weight” as used herein refers to weight average molecular weight (Mw), the units of which are g/mol or Daltons.

In some examples, the term “on” may mean that one component or material is positioned directly on another component or material. When one is directly on another, the two are in contact with each other. For example, the fixer fluid may be applied on the textile fabric so that it is directly on and in contact with the textile fabric.

In other examples, the term “on” may mean that one component or material is positioned indirectly on another component or material. By indirectly on, it is meant that an additional component or material may be positioned between the two components or materials. For example, the pre-treatment fluid may be applied on the fixer fluid which has been applied on the textile fabric, and thus the pre-treatment fluid may be considered to be on, or in indirect contact with, the textile fabric.

The viscosity measurements set forth herein represent those measured by a viscometer at a particular temperature and at a particular shear rate (s⁻¹) or at a particular speed. The temperature and shear rate or temperature and speed are identified with individual values. Viscosity may be measured, for example, by a VISCOLITE™ viscometer (from Hydromotion) or another suitable instrument.

A weight percentage that is referred to as “wt % active” refers to the loading of an active component of a dispersion or other formulation that is present in the pre-treatment fluid, the fixer fluid, or the white inkjet ink. For example, the white pigment may be present in a water-based formulation (e.g., a stock solution or dispersion) before being incorporated into the white inkjet ink. In this example, the wt % actives of the white pigment accounts for the loading (as a weight percent) of the white pigment that is present in the white inkjet ink, and does not account for the weight of the other components (e.g., water, etc.) that are present in the formulation with the white pigment.

Sets and Kits

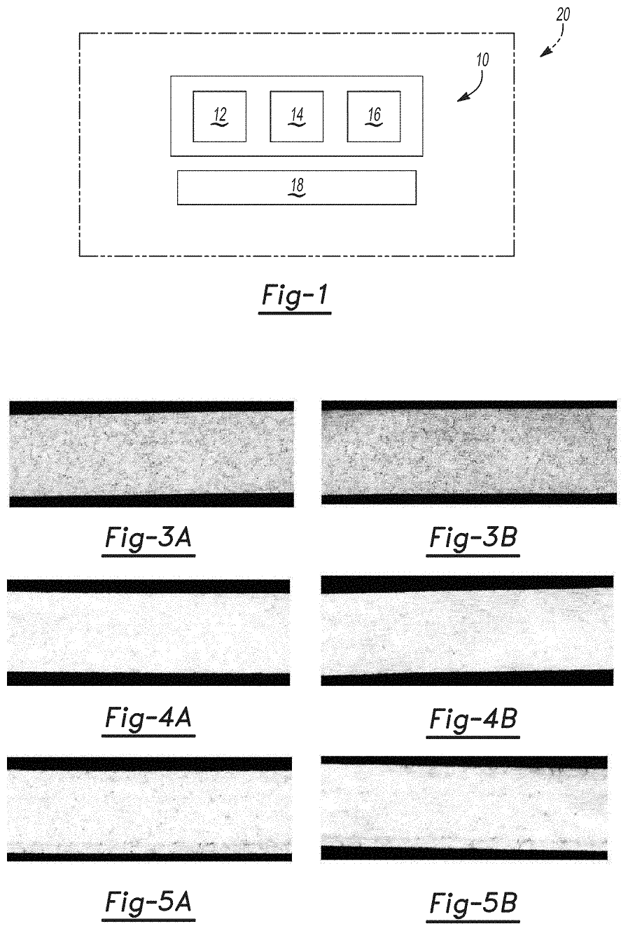

An example of the inkjet fluid set disclosed herein is shown schematically in FIG. 1. As depicted, the inkjet fluid set 10 comprises the colorless pre-treatment fluid 12 including a first polymeric binder selected from the group consisting of an acrylic copolymer, an acrylamide copolymer, a polyester-polyurethane, and a polyether-polyurethane and a pre-treatment vehicle; a colorless fixer fluid 14 including a cationic polymer and a fixer vehicle; and a white inkjet ink 16 including a white pigment, a second polymeric binder, and an ink vehicle. It is to be understood that any example of the pre-treatment fluid 12, the fixer fluid 14, and the white inkjet ink 16 disclosed herein may be used in the examples of the inkjet fluid set 10.

In the examples disclosed herein, each of the fluids 12, 14 and the ink 16 is formulated for digital printing.

When used in a thermal inkjet printer, the viscosity of each of the pre-treatment fluid 12, the fixer fluid 14, and the white inkjet ink 16 may be modified to range from about 1 centipoise (cP) to about 10 cP (at a temperature ranging from 20° C. to 25° C. and at a shear rate of about 3,000 Hz). When used in a piezoelectric printer, the viscosity of each of the pre-treatment fluid 12, the fixer fluid 14, and the white inkjet ink 16 may be modified to range from about 2 cP to about 20 cP (at a temperature ranging from 20° C. to 25° C. and at a shear rate of about 3,000 Hz), depending on the type of the printhead that is being used (e.g., low viscosity printheads, medium viscosity printheads, or high viscosity printheads).

In any example of the inkjet fluid set 10, each of the fluids 12, 14 and the ink 16 may be maintained in separate containers (e.g., respective reservoirs/fluid supplies of respective inkjet cartridges) or separate compartments (e.g., respective reservoirs/fluid supplies) in a single container (e.g., inkjet cartridge) until printing. This avoids potentially deleterious effects, such as non-printability and/or binder crashing (e.g., if the binders of the fluid 12 and the fixer of the fluid 14 were prematurely mixed) and premature pigment crashing (e.g., if the fixer of the fluid 14 and the ink 16 were prematurely mixed).

Examples of the inkjet fluid kit 10 may also be part of a kit 20 for textile printing, which is also shown schematically in FIG. 1. In an example, the kit 20 for textile printing includes the textile fabric 20 selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof; the colorless pre-treatment fluid 12 consisting of a first polymeric binder selected from the group consisting of an acrylic copolymer, an acrylamide copolymer, a polyester-polyurethane, and a polyether-polyurethane and a pre-treatment vehicle; the colorless fixer fluid 14 consisting of the cationic polymer and the fixer vehicle; and the white inkjet ink 16 including the white pigment, the second polymeric binder, and the ink vehicle. It is to be understood that any example of the pre-treatment fluid 12, the fixer fluid 14, and the white inkjet ink 16 disclosed herein may be used in the examples of the textile printing kit 20.

Pre-Treatment Fluid

The pre-treatment fluid 12 includes a first polymeric binder selected from the group consisting of an acrylic copolymer, an acrylamide copolymer, a polyester-polyurethane, and a polyether-polyurethane; and a pre-treatment vehicle.

The polymeric binder of the pre-treatment fluid 12 is selected from the group consisting of an acrylic copolymer, an acrylamide copolymer, a polyester-polyurethane, and a polyether-polyurethane. It is to be understood that the polymeric binder of the pre-treatment fluid 12 is not a silicone. The polymeric binder in the pre-treatment fluid 12 has anionic functional groups that can interact with the cationic functional groups of the cationic polymer in the fixer fluid 14 when the two are printed on the textile fabric 20. It is to be further understood that the polymeric binder of the pre-treatment fluid 12 may be the same as, or is at least compatible with, the polymeric binder of the white inkjet ink 16. By “compatible with,” it is meant that the polymeric binder of the white inkjet ink 16 and the polymeric binder of the pre-treatment fluid 12 do not form a gel or precipitates when mixed.

In one example, the polymeric binder in the pre-treatment fluid 12 is an acrylic copolymer or an acrylamide copolymer. Either of these copolymers may be a latex, meaning that the copolymer particles form a stable dispersion in an aqueous medium (e.g., the pre-treatment vehicle).

The acrylic copolymer or an acrylamide copolymer is anionic.

The acrylic copolymer refers to copolymers formed from at least one acrylic monomer or acrylate monomer. The terms “acrylic” and “acrylate” can be used interchangeably, as acrylates and methacrylates are salts and esters of acrylic acid and methacrylic acid, respectively. The presence of one compound over another can be a function of pH. Furthermore, even if the monomer used to form the copolymer was in the form of a (meth)acrylic acid during preparation, pH modifications during preparation or subsequently when added to the pre-treatment vehicle can impact the nature of the moiety as well (acid form vs. salt or ester form). Thus, a monomer or a moiety of a copolymer described as (meth)acrylic acid or as (meth)acrylate should not be read so rigidly as to not consider relative pH levels, ester chemistry, and other general organic chemistry concepts.

Additionally, the use of “(meth)” in conjunction with acrylate, acrylic acid, acrylamide, or the like means that the functional group may or may not include the methyl group.

The particles of any of the acrylic copolymers and acrylamide copolymers disclosed herein may be formed with a copolymerizable surfactant, such as such as HITENOL™ BC-10, BC-30, KH-05, or KH-10 (commercially available from DKS Co. Ltd.).

In some examples, the particles of the acrylic copolymer or the acrylamide copolymer can include a single heteropolymer phase. As examples, the acrylic copolymer or the acrylamide copolymer can include a polymerization product of monomers including: the copolymerizable surfactant; an aromatic monomer selected from the group consisting of styrene, an aromatic (meth)acrylate monomer, and an aromatic (meth)acrylamide monomer; and multiple aliphatic (meth)acrylate monomers or multiple aliphatic (meth)acrylamide monomers. As one specific example, the acrylate copolymer can include a polymerization product of the copolymerizable surfactant, styrene, methyl methacrylate, butyl acrylate, and methacrylic acid.

In other examples, the particles of the acrylic copolymer or the acrylamide copolymer can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

In the two phase examples, the two phases can be physically separated in the particles, such as in a core-shell configuration, a two-hemisphere configuration, smaller spheres of one phase distributed in a larger sphere of the other phase, interlocking strands of the two phases, and so on.

The first heteropolymer composition can be present in the particles in an amount ranging from about 15 wt % to about 70 wt % of a total weight of the copolymer particle and the second heteropolymer composition can be present in an amount ranging from about 30 wt % to about 85 wt % of the total weight of the copolymer particle. In other examples, the first heteropolymer composition can be present in an amount ranging from about 30 wt % to about 40 wt % of a total weight of the copolymer particle and the second heteropolymer composition can be present in an amount ranging from about 60 wt % to about 70 wt % of the total weight of the copolymer particle. In one specific example, the first heteropolymer composition can be present in an amount of about 35 wt % of a total weight of the copolymer particle and the second heteropolymers composition can be present in an amount of about 65 wt % of the total weight of the copolymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. The cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

Whether the particles of the acrylic copolymer or the acrylamide copolymer are single phase particles or two phase particles, they can have an average particle size ranging from 20 nm to 500 nm, from 50 nm to 350 nm, or from 150 nm to 270 nm. The “average particle size” refers to the volume-weighted mean diameter of a particle distribution (i.e., mean of a particle size distribution weighted by volume). In one example, this range refers to the D50 particle size of a particle distribution (half of the particles in the distribution are above the D50 value and half the particle in the distribution are below the D50 value). In an example, the particles of the acrylic copolymer or the acrylamide copolymer may have a D50 particle size ranging from about 150 nm to about 350 nm.

The particles of the acrylic copolymer or the acrylamide copolymer can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in an aqueous latex dispersion.

Examples of anionic acrylic copolymer latex binders include JANTEX™ Binder 924 and JANTEX™ Binder 45 NRF (both of which are available from Jantex). Other examples of anionic acrylic latex binders include TEXICRYL™ 13-216, TEXICRYL™ 13-217, TEXICRYL™ 13-220, TEXICRYL™ 13-294, TEXICRYL™ 13-295, TEXICRYL™ 13-503, and TEXICRYL™ 13-813 (each of which is available from Scott Bader). Still other examples of anionic acrylic copolymer latex binders include TUBIFAST™ AS 4010 FF, TUBIFAST™ AS 4510 FF, and TUBIFAST™ AS 5087 FF (each of which is available from CHT).

Another example of the polymeric binder in the pre-treatment fluid 12 is the polyester-polyurethane.

In an example, the polyester-polyurethane binder is an anionic sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated C₄ to C₁₀ carbon chains and/or an alicyclic carbon moiety, that is devoid of an aromatic moiety, or ii) an aromatic compound including an aromatic moiety and multiple saturated carbon chain portions ranging from C₄ to C₁₀ in length.

In one example, the anionic sulfonated polyester-polyurethane binder is aliphatic, including saturated carbon chains as part of the polymer backbone or as a side-chain thereof, e.g., C₂ to C₁₀, C₃ to C₉, or C₃ to C₆ alkyl. The sulfonated polyester-polyurethane binder can also contain an alicyclic carbon moiety. These polyester-polyurethane binders can be described as “aliphatic” because these carbon chains are saturated and because they are devoid of aromatic moieties. An example of a commercially available anionic aliphatic polyester-polyurethane binder that can be used is IMPRANIL® DLN-SD (Mw 133,000; Acid Number 5.2; Tg −47° C.; Melting Point 175-200° C.) from Covestro. Example components used to prepare the IMPRANIL® DLN-SD or other anionic aliphatic polyester-polyurethane binders suitable for the examples disclosed herein can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyldiamine (e.g., (2, 4, 4)-trimethylhexane-1,6-diamine (TMD), isophorone diamine (IPD)); C₄ to C₁₀ alkyl diisocyanates (e.g., hexamethylene diisocyanate (HDI), (2, 4, 4)-trimethylhexane-1,6-diisocyanate (TMDI)); alicyclic diisocyanates (e.g. isophorone diisocyanate (IPDI), 1,3-bis(isocyanatomethyl)cyclohexane (H6XD1)); diamine sulfonic acids (e.g., 2-[(2-aminoethyl)amino]ethanesulfonic acid); etc.

Some specific examples of the anionic polyester-polyurethane binder include sulfonated groups without carboxylate groups. One specific example of this type of polyester-polyurethane is set forth in the example section.

Alternatively, the sulfonated polyester-polyurethane binder can be aromatic (or include an aromatic moiety), and thus includes both sulfonate groups and an aromatic moiety. Some of these examples may also include aliphatic chains. An example of an anionic aromatic polyester-polyurethane binder that can be used is DISPERCOLL® U42. Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of anionic polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight ranging from about 20,000 to about 300,000. In some examples of the pre-treatment fluid 12, the polymeric binder is the polyester-polyurethane binder, and the polyester-polyurethane binder has a weight average molecular weight ranging from about 20,000 to about 300,000. As examples, the weight average molecular weight can range from about 50,000 to about 1,000,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the pre-treatment fluid 12, the polymeric binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device. As mentioned, the term “average particle size” refers to a volume-weighted mean diameter of a particle distribution.

Still another example of the polymeric binder in the pre-treatment fluid 12 is the polyether-polyurethane. The polyether-polyurethane may be anionic and aliphatic. Examples of anionic, aliphatic polyether-polyurethanes that may be used include IMPRANIL® LP DSB 1068 or IMPRANIL® LP DSB 1069 (Covestro (Germany)) or HYDRAN® WLS-201 (DIC Corp. (Japan)). An example of an anionic, aromatic polyether-polyurethanes that may be used includes IMPRANIL® DAH (Covestro (Germany).

In some examples of the pre-treatment fluid 12, the polymeric binder is present in an amount ranging from about 1 wt % active to about 20 wt % active, based on a total weight of the pre-treatment fluid 12. In other examples, the polymeric binder can be present, in the pre-treatment fluid 12, in an amount ranging from about 2 wt % active to about 15 wt % active, or from about from about 3 wt % active to about 11 wt % active, or from about 6 wt % active to about 10 wt % active, each of which is based on the total weight of the pre-treatment fluid 12.

The pre-treatment fluid 12 may be prepared by adding the desired amount of the polymeric binder to the pre-treatment vehicle and mixing.

The pre-treatment vehicle refers to the liquid in which the polymeric binder is mixed to form the pre-treatment fluid 12. The pre-treatment vehicle consists of water; or water and a non-ionic or anionic surfactant; or water, a co-solvent, the non-ionic or anionic surfactant, an anti-microbial agent, and an anti-decel agent. In still other examples, the pre-treatment vehicle includes water and any one or more of the listed additives. Any example of the pre-treatment vehicle may also include an anti-kogation agent and/or a pH adjuster.

The balance of the pre-treatment fluid 12 is water, and thus the amount of water included depends upon the amount of polymeric binder and any other additives that may be included. In an example, purified water or deionized water may be used. It is to be understood that the water included in the pre-treatment fluid 12 may be: i) part of the binder dispersion and/or ii) part of the pre-treatment vehicle. In examples where the pre-treatment fluid 12 is a thermal inkjet fluid, the pre-treatment vehicle includes at least 70% by weight of water.

When included, the co-solvent in the pre-treatment fluid 12 may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, lactams, caprolactams, formamides, acetamides, and long chain alcohols. Examples of such compounds include primary aliphatic alcohols, secondary aliphatic alcohols, 1,2-alcohols, 1,3-alcohols, 1,5-alcohols, alkyldiols, ethylene glycol alkyl ethers, propylene glycol alkyl ethers (e.g., DOWANOL™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples include butyl alcohol, benzyl alcohol, 2-ethyl-2-(hydroxymethyl)-1,3-propane diol (EPHD), dimethyl sulfoxide, sulfolane, ethylene glycol, diethylene glycol, propylene glycol, butylene glycol, triethylene glycol, 1,3-propanediol, 1,5-pentanediol, 1,2-hexanediol, 1,2,6-hexanetriol, glycerin, trimethylolpropane, xylitol, an ethylene oxide adduct of diglycerin, 2-pyrrolidone, 1-(2-hydroxyethyl)-2-pyrrolidone, N-methyl-2-pyrrolidone, and cyclohexylpyrrolidone.

The co-solvent(s) may be present in the pre-treatment fluid 12 in an amount ranging from about 4 wt % active to about 30 wt % active (based on the total weight of the pre-treatment fluid 12). In an example, the total amount of co-solvent(s) present in the pre-treatment fluid 12 is about 10 wt % active (based on the total weight of the pre-treatment fluid 12).

When included, the surfactant in the pre-treatment fluid 12 may be any non-ionic or anionic surfactant.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicone surfactants such as a polysiloxane oxyethylene adduct or a polyether-modified siloxane; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

More specific examples of suitable non-ionic surfactants include a silicone-free alkoxylated alcohol surfactant such as, for example, TECO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345 (silicone surfactant), BYK® 346 (silicone surfactant), BYK® 347 (silicone surfactant), BYK® 348 (polyether-modified siloxane), BYK® 349 (silicone surfactant) (all of which are available from BYK).

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate.

In any of the examples disclosed herein, the surfactant may be present in the pre-treatment fluid 12 in an amount ranging from about 0.01 wt % active to about 5 wt % active (based on the total weight of the pre-treatment fluid 12). In an example, the surfactant is present in the pre-treatment fluid 12 in an amount ranging from about 0.05 wt % active to about 3 wt % active, based on the total weight of the pre-treatment fluid 12. In another example, the surfactant is present in the pre-treatment fluid 12 in an amount of about 0.2 wt % active, based on the total weight of the pre-treatment fluid 12.

Some examples of the pre-treatment fluid 12 may also include anti-microbial agent(s). Anti-microbial agents are also known as biocides and/or fungicides. Examples of suitable anti-microbial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of anti-microbial agent(s) in the pre-treatment fluid 12 ranges from about 0.01 wt % active to about 0.05 wt % active (based on the total weight of the pre-treatment fluid 12). In another example, the total amount of anti-microbial agent(s) in the pre-treatment fluid 12 is about 0.044 wt % active (based on the total weight of the pre-treatment fluid 12).

The pre-treatment fluid 12 may also include anti-decel agent(s). The anti-decel agent may function as a humectant. Decel refers to a decrease in drop velocity over time with continuous firing of an inkjet printhead. In the examples disclosed herein, the anti-decel agent(s) may be included to assist in preventing decel. In some examples, the anti-decel agent may improve the jettability of the pre-treatment fluid 12. An example of a suitable anti-decel agent is ethoxylated glycerin having the following formula:

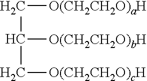

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

When included, the anti-decel agent(s) may be present in an amount ranging from about 0.2 wt % active to about 5 wt % active (based on the total weight of the pre-treatment fluid 12). In an example, the anti-decel agent is present in the pre-treatment fluid 12 in an amount of about 1 wt % active, based on the total weight of the pre-treatment fluid 12.

An anti-kogation agent may also be included in the pre-treatment fluid 12 when it is to be thermal inkjet printed. Kogation refers to the deposit of dried printing liquid (e.g., polymeric binder) on a heating element of a thermal inkjet printhead. Anti-kogation agent(s) is/are included to assist in preventing the buildup of kogation. In some examples, the anti-kogation agent may improve the jettability of the pre-treatment fluid 12.

Examples of suitable anti-kogation agents include oleth-3-phosphate (commercially available as CRODAFOS™ O3A or CRODAFOS™ N-3A), oleth-5-phosphate (commercially available as CRODAFOS™ O5A), or dextran 500k. Other suitable examples of the anti-kogation agents include CRODAFOS™ HCE (phosphate-ester from Croda Int.), CRODAFOS™ CES (phosphate-based emulsifying and conditioning wax from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent(s) may be present in the pre-treatment fluid 12 in a total amount ranging from about 0.1 wt % active to about 1.5 wt % active, based on the total weight of the pre-treatment fluid 12. In an example, the anti-kogation agent(s) is/are present in an amount of about 0.5 wt % active, based on the total weight of the pre-treatment fluid 12.

The pre-treatment fluid 12 has a pH ranging from about 6 to about 12. Suitable pH ranges for examples of the pre-treatment fluid 12 may include from about 6 to about 8, or from about 9 to about 11. In one example, the pH of the pre-treatment fluid 12 is about 6.5. In some instances, a pH adjuster may be added to the pre-treatment fluid 12 to obtain the desired pH. Examples of suitable pH adjusters for the pre-treatment fluid 12 include metal hydroxide bases, such as potassium hydroxide (KOH), sodium hydroxide (NaOH), etc. Other examples of suitable pH adjusters for the pre-treatment fluid 12 include acids, such as nitric acid or methanesulfonic acid, etc. In an example, the metal hydroxide base or the acid may be added to the pre-treatment fluid 12 in the form of an aqueous solution, such as an aqueous solution including 5 wt % of the metal hydroxide base (e.g., a 5 wt % active potassium hydroxide aqueous solution) or including 99% methanesulfonic acid (e.g., a 99 wt % active methanesulfonic acid aqueous solution).

In an example, the total amount of pH adjuster(s) in the pre-treatment fluid 12 ranges from greater than 0 wt % to about 0.5 wt % (based on the total weight of the pre-treatment fluid 12). In another example, the total amount of pH adjuster(s) in the pre-treatment fluid 12 ranges from about 0.01 wt % to about 0.2 wt %. In another example, the total amount of pH adjuster(s) in the pre-treatment fluid 12 is about 0.03 wt % (based on the total weight of the pre-treatment fluid 12). The amount of pH adjuster added depends on the desired pH, and the pH adjuster may be added until the desired pH of the pre-treatment fluid 12 is achieved.

The pre-treatment 12 is also colorless because it has no colorant added thereto.

The following are some examples of the pre-treatment fluid 12. In one example, the polymeric binder in the colorless pre-treatment fluid 12 includes the polyester-polyurethane; the polyester-polyurethane is an aliphatic chain including sulfonate groups without carboxylate groups; and the pre-treatment vehicle consists of: water; or water and a non-ionic or anionic surfactant; or water, a co-solvent, the non-ionic or anionic surfactant, an anti-microbial agent, and an anti-decel agent. In another example, the polymeric binder in the colorless pre-treatment fluid 12 includes the polyester-polyurethane; the polyester-polyurethane includes sulfonate groups and an aromatic moiety; and the pre-treatment vehicle consists of: water and a non-ionic or anionic surfactant; or water, a co-solvent, the non-ionic or anionic surfactant, an anti-microbial agent, and an anti-decel agent. In still another example, the polymeric binder in the colorless pre-treatment fluid 12 includes the polyether-polyurethane; the polyether-polyurethane is an anionic, aliphatic chain; and the pre-treatment vehicle consists of: water and a non-ionic or anionic surfactant; or water, a co-solvent, the non-ionic or anionic surfactant, an anti-microbial agent, and an anti-decel agent.

Fixer Fluid

The fixer fluid 14 includes a cationic polymer and a fixer vehicle. In some examples, the fixer fluid 14 consists of the cationic polymer and the fixer vehicle. In other examples, the fixer fluid 14 may include additional components.

The cationic polymer included in the fixer fluid 14 has a weight average molecular weight ranging from about 3,000 to about 3,000,000.

In some examples, the cationic polymer of the fixer fluid 14 is selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; poly(dimethylamine-co-epichlorohydrin); a polyethylenimine; a polyamide epichlorohydrin resin; a polyamine epichlorohydrin resin; and a combination thereof.

Some examples of commercially available polyamine epichlorohydrin resins may include CREPETROL™ 73, KYMENE™ 736, KYMENE™ 736NA, POLYCUP™ 7360, and POLYCUP™ 7360A, each of which is available from Solenis LLC. The polyamine epichlorohydrin may be derived from the reaction of a polyalkylene polyamine (e.g., ethylenediamine, bishexamethylenetriamine, hexamethylenediamine, etc.) with an epihalohydrin (e.g., epichlorohydrin). More particularly, the polyalkylene polyamine reacts with the epihalohydrin to form an epoxide-containing polyamine, which then rearranges by itself to form a structure represented by either of the following:

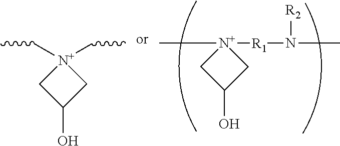

which contain an azetidinium group (shown in an uncrosslinked stated), where R₁ can be a substituted or unsubstituted C₂-C₁₂ linear alkyl group and R₂ is H or CH₃. These polymers are often referred to as PAmE resins.

In an example, the cationic polymer of the fixer fluid 14 is present in an amount ranging from about 1 wt % active to about 15 wt % active based on a total weight of the fixer fluid 14. In further examples, the cationic polymer is present in an amount ranging from about 1 wt % active to about 10 wt % active; or from about 4 wt % active to about 8 wt % active; or from about 2 wt % active to about 7 wt % active; or from about 6 wt % active to about 10 wt % active, based on a total weight of the fixer fluid 14.

In addition to the cationic polymer, the fixer fluid 14 also includes the fixer vehicle. As used herein, the terms “fixer vehicle” and “second aqueous vehicle” may refer to the liquid in which the cationic polymer is mixed to form the fixer fluid 14.

In an example of the fixer fluid 14, the fixer vehicle includes a co-solvent, a surfactant, an anti-kogation agent, and a balance of water. In another example, the fixer fluid 14 further comprises a pH adjuster. As such, some examples of the fixer vehicle (and thus the fixer fluid 14) include a co-solvent, a surfactant, an anti-kogation agent, and/or a pH adjuster.

The co-solvent in the fixer fluid 14 may be any examples of the water soluble or water miscible co-solvent set forth herein for the pre-treatment fluid 12.

The co-solvent(s) may be present in the fixer fluid 14 an amount ranging from about 3 wt % to about 30 wt % (based on the total weight of the fixer fluid 14). In an example, the total amount of co-solvent(s) present in the fixer fluid 14 is about 4 wt % (based on the total weight of the fixer fluid 14).

The surfactant in the fixer fluid 14 may be any of the non-ionic surfactants set forth herein for the pre-treatment fluid 12 or may be a cationic surfactant.

Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide.

In any of the examples disclosed herein, the surfactant may be present in the fixer fluid 14 in an amount ranging from about 0.01 wt % active to about 5 wt % active (based on the total weight of the fixer fluid 14). In an example, the surfactant is present in the fixer fluid 14 in an amount ranging from about 0.05 wt % active to about 3 wt % active, based on the total weight of the fixer fluid 14. In another example, the surfactant is present in the fixer fluid 14 in an amount of about 0.3 wt % active, based on the total weight of the fixer fluid 14.

An anti-kogation agent may also be included in the fixer fluid 14 when it is to be thermal inkjet printed. Any example of the anti-kogation agent(s) set forth herein may be used in the fixer fluid 14.

The anti-kogation agent(s) may be present in the fixer fluid 14 in a total amount ranging from about 0.1 wt % active to about 1.5 wt % active, based on the total weight of the fixer fluid 14. In an example, the anti-kogation agent(s) is/are present in an amount of about 0.5 wt % active, based on the total weight of the fixer fluid 14.

A pH adjuster may also be included in the fixer fluid 14. A pH adjuster may be included in the fixer fluid 14 to achieve a desired pH (e.g., about 4) and/or to counteract any slight pH increase that may occur over time. An example of a suitable pH adjuster that may be used in the fixer fluid 14 includes acetic acid, formic acid, glycolic acid, citric acid, sulfuric acid, hydrochloric acid, methane sulfonic acid, nitric acid, and phosphoric acid. In an example, the total amount of pH adjuster(s) in the fixer fluid 14 ranges from greater than 0 wt % to about 0.1 wt % (based on the total weight of the fixer fluid 14). In another example, the total amount of pH adjuster(s) in the fixer fluid 14 is about 0.03 wt % (based on the total weight of the fixer fluid 14).

The pH of the fixer fluid 14 may be less than 7. As examples, the pH may range from about 2 to less than 7, from about 5.5 to less than 7, from about 5 to less than 6.6, or from about 5.5 to about 6.6. In one example, the pH of the fixer fluid 14 is about 4.

The balance of the fixer fluid 14 is water. As such, the weight percentage of the water present in the fixer fluid 14 will depend, in part, upon the weight percentages of the other components. The water may be purified water or deionized water.

White Inkjet Ink

The white inkjet ink 16 includes a white pigment, a polymeric binder, and an ink vehicle. In some examples, the white inkjet ink 16 consists of the white pigment, the polymeric binder, and the ink vehicle. In other examples, the white inkjet ink 16 may include additional components.

The white pigment may be incorporated into the ink vehicle to form the white inkjet ink 16. The white pigment may be incorporated as a white pigment dispersion. The white pigment dispersion may include a white pigment and a separate pigment dispersant.

For the white pigment dispersions disclosed herein, it is to be understood that the white pigment and separate pigment dispersant (prior to being incorporated into the ink vehicle to form the white inkjet ink 16), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the white pigment dispersion become part of the ink vehicle in the white inkjet ink 16.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from about 10 nm to about 2000 nm. In some examples, the average particle size ranges from about 120 nm to about 2000 nm, from about 150 nm to about 1000 nm, from about 150 nm to about 750 nm, or from about 200 nm to about 500 nm. Smaller particles may be desirable depending upon the jetting architecture that is used. As mentioned, the term “average particle size”, as used herein, refers to a volume-weighted mean diameter of a particle distribution.

The amount of the white pigment in the dispersion may range from about 20 wt % to about 60 wt %, based on the total weight of the dispersion. The white pigment dispersion may then be incorporated into the ink vehicle so that the white pigment is present in an active amount that is suitable for the inkjet printing architecture that is to be used. In an example, the white pigment dispersion is incorporated into the ink vehicle so that the white pigment is present in an amount ranging from about 3 wt % active to about 20 wt % active, based on a total weight of the white inkjet ink 16. In other examples, the white pigment dispersion is incorporated into the ink vehicle so that the white pigment is present in an amount ranging from about 5 wt % active to about 20 wt % active, or from about 5 wt % active to about 15 wt % active, based on a total weight of the white inkjet ink 16. In still another example, the white pigment dispersion is incorporated into the ink vehicle so that the white pigment is present in an amount of about 10 wt % active or about 9.75 wt % active, based on a total weight of the white inkjet ink 16.

The white pigment may be dispersed with the pigment dispersant. In an example, the pigment dispersant is selected from the group consisting of a water-soluble acrylic acid polymer, a branched co-polymer of a comb-type structure with polyether pendant chains and acidic anchor groups attached to a backbone, and a combination thereof.

Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation.

Some examples of the branched co-polymer of the comb-type structure with polyether pendant chains and acidic anchor groups attached to the backbone include DISPERBYK®-190 (an acid number of about 10 mg KOH/g) and DISPERBYK®-199, both available from BYK Additives and Instruments, as well as DISPERSOGEN® PCE available from Clariant.

The amount of the pigment dispersant in the dispersion may range from about 0.1 wt % to about 2 wt %, based on the total weight of the dispersion. The white pigment dispersion may then be incorporated into the ink vehicle so that the pigment dispersant is present in an amount ranging from about 0.01 wt % active to about 0.5 wt % active, based on a total weight of the white inkjet ink 16. In one of these examples, the dispersant is present in an amount of about 0.04 wt % active, based on a total weight of the white inkjet ink 16.

In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from about 0.02 wt % active to about 0.4 wt % active, and the branched co-polymer of the comb-type structure with polyether pendant chains and acidic anchor groups attached to the backbone is present in an amount ranging from about 0.03 wt % active to about 0.6 wt % active. In one of these examples, the water-soluble acrylic acid polymer is present in an amount of about 0.09 wt % active, and the branched co-polymer of the comb-type structure with polyether pendant chains and acidic anchor groups attached to the backbone is present in an amount of about 0.14 wt % active.

The white inkjet ink 16 also includes a polymeric binder. The polymeric may be same as or different than the polymeric binder in the pre-treatment fluid 12 as long as it is compatible with the polymeric binder of the pre-treatment fluid 12. Any example of the polymeric binder set forth for the pre-treatment fluid 12 may be used in the white inkjet ink 16.

In some examples of the white inkjet ink 16, the polymeric binder is present in an amount ranging from about 1 wt % active to about 20 wt % active, based on a total weight of the white inkjet ink 16. In other examples, the polymeric binder can be present, in the white inkjet ink 16, in an amount ranging from about 2 wt % active to about 15 wt % active, or from about from about 3 wt % active to about 11 wt % active, or from about 4 wt % active to about 10 wt % active, or from about 5 wt % active to about 9 wt % active, each of which is based on the total weight of the white inkjet ink 16.

The polymeric binder (prior to being incorporated into the ink vehicle) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the binder dispersion become part of the vehicle in the white inkjet ink 16.

In addition to the white pigment and the polymeric binder, the white inkjet ink 16 includes an ink vehicle.

As used herein, the term ink vehicle refers to the liquid with which the pigment (dispersion) and polymeric binder (dispersion) are mixed to form a thermal or a piezoelectric inkjet ink(s) composition. A wide variety of vehicles may be used with the ink composition(s) of the present disclosure. The ink vehicle may include water and any of: a co-solvent, a surfactant, an anti-kogation agent, an anti-decel agent, an anti-microbial agent, a rheology modifier, a pH adjuster, or combinations thereof. In an example of the white inkjet ink 16, the ink vehicle includes water and a co-solvent. In another example of the white inkjet ink 16, the ink vehicle consists of water and the co-solvent, the anti-kogation agent, the anti-decel agent, the surfactant, the anti-microbial agent, a rheology modifier, a pH adjuster, or a combination thereof. In still another example, the ink vehicle consists of the anti-kogation agent, the anti-decel agent, the surfactant, the anti-microbial agent, a rheology modifier, a pH adjuster, and water.

The co-solvent in the white inkjet ink 16 may be any example of the co-solvents set forth herein for the pre-treatment fluid 12 or fixer fluid 14, in any amount set forth herein for the pre-treatment fluid 12 or fixer fluid 14 (except that the amount(s) are based on the total weight of the white inkjet ink 16 instead of pre-treatment fluid 12 or the fixer fluid 14).

The surfactant in the white inkjet ink 16 may be any of the anionic and/or non-ionic surfactants set forth herein for the pre-treatment fluid. Furthermore, the anionic and/or non-ionic surfactant may be included in the white inkjet ink 16 in any amount set forth herein for the surfactant in the pre-treatment fluid 12 (except that the amount(s) are based on the total weight of the white inkjet ink 16 instead of the pre-treatment fluid 12).

An anti-kogation agent may also be included in the vehicle of the white inkjet ink 16, for example, when the white inkjet ink 16 is to be applied via a thermal inkjet printhead. As mentioned herein, the anti-kogation agent(s) is/are included to assist in preventing the buildup of kogation, and thus may improve the jettability of the white inkjet ink 16. The anti-kogation agent in the white inkjet ink 16 may be any of the anti-kogation agents set forth herein for the fixer fluid 14, and may be included in the white inkjet ink 16 in any amount set forth herein for the anti-kogation agent in the fixer fluid 14 (except that the amount(s) are based on the total weight of the white inkjet ink 16 instead of the fixer fluid 14).

The ink vehicle may also include anti-decel agent(s). The anti-decel agent may be any of the anti-decel agents set forth herein for the pre-treatment fluid 12, and may be included in the white inkjet ink 16 in any amount set forth herein for the anti-decel agent in the pre-treatment fluid 12 (except that the amount(s) are based on the total weight of the white inkjet ink 16 instead of the pre-treatment fluid 12).

The vehicle of the white inkjet ink 16 may also include anti-microbial agent(s). Any of the anti-microbial agents are set forth herein may be used. In an example, the total amount of anti-microbial agent(s) in the white inkjet ink 16 ranges from about 0.01 wt % active to about 0.05 wt % active (based on the total weight of the white inkjet ink 16). In another example, the total amount of anti-microbial agent(s) in the white inkjet ink 16 is about 0.044 wt % active (based on the total weight of the white inkjet ink 16).

The ink vehicle may also include rheology additive(s). The rheology additive may be added to adjust the viscosity of the white inkjet ink 16 and to aid in redispersibility of the white inkjet ink after it has sat idle. Examples of suitable rheology additives include boehmite, anionic cellulose (e.g., carboxymethyl cellulose, cellulose sulfate, nitrocellulose, and combinations thereof), and combinations thereof.

In an example, the total amount of rheology additive(s) in the white inkjet ink 16 ranges from about 0.005 wt % active to about 5 wt % active (based on the total weight of the white inkjet ink 16).

The ink vehicle of the white inkjet ink 16 may also include a pH adjuster. A pH adjuster may be included in the white inkjet ink 16 to achieve a desired pH of greater than 7. Suitable pH ranges for examples of the ink composition can be from greater than 7 to about 11, from greater than 7 to about 10, from about 7.2 to about 10, from about 7.5 to about 10, from about 8 to about 10, from about 7 to about 9, from about 7.2 to about 9, from about 7.5 to about 9, from about 8 to about 9, from about 7 to about 8.5, from about 7.2 to about 8.5, from about 7.5 to about 8.5, from about 8 to about 8.5, from about 7 to about 8, from about 7.2 to about 8, or from about 7.5 to about 8.

The type and amount of pH adjuster that is added may depend upon the initial pH of the white inkjet ink 16 and the desired final pH of the white inkjet ink 16. If the initial pH is too high, an acid may be added to lower the pH, and if the initial pH is too low, a base may be added increase the pH. Examples of suitable pH adjusters include metal hydroxide bases, such as potassium hydroxide (KOH), sodium hydroxide (NaOH), etc. In an example, the metal hydroxide base may be added to the while inkjet ink 16 in an aqueous solution. In another example, the metal hydroxide base may be added to the white inkjet ink 16 in an aqueous solution including 5 wt % of the metal hydroxide base (e.g., a 5 wt % potassium hydroxide aqueous solution). Any of the acidic pH adjusters mentioned herein may also be used.

In an example, the total amount of pH adjuster(s) in the white inkjet ink 16 ranges from greater than 0 wt % to about 0.1 wt % (based on the total weight of the white inkjet ink 16). In another example, the total amount of pH adjuster(s) in the white inkjet ink 16 is about 0.03 wt % (based on the total weight of the white inkjet ink 16).

The balance of the white inkjet ink 16 is water. In an example, purified water or deionized water may be used. The water included in the white inkjet ink 16 may be: i) part of the pigment dispersion and/or binder dispersion, ii) part of the ink vehicle, iii) added to a mixture of the pigment dispersion, and/or binder dispersion and the ink vehicle, or iv) a combination thereof. In examples where the white inkjet ink 16 is a thermal inkjet ink, the ink vehicle includes at least 70% by weight of water. In examples where the ink composition is a piezoelectric inkjet ink, the liquid vehicle is a solvent based vehicle including at least 50% by weight of the co-solvent.

One specific example of the white inkjet ink 16 includes the pigment in an amount ranging from about 1 wt % active to about 10 wt % active based on the total weight of the white inkjet ink 16; the polymeric binder in an amount ranging from about 2 wt % active to about 10 wt % active of the total weight of the white inkjet ink 16; an additive selected from the group consisting of a non-ionic surfactant, an anti-microbial agent, an anti-decel agent, a rheology modifier, and combinations thereof; and the liquid vehicle, which includes water and an organic solvent (e.g., the co-solvent disclosed herein).

Textile Fabrics

In the examples disclosed herein, the textile fabric 18 may be selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric 18 is selected from the group consisting of cotton fabrics and cotton blend fabrics.

It is to be understood that organic textile fabrics and/or inorganic textile fabrics may be used for the textile fabric 18. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric 18 may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate 18 can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or anti-microbial treatment to prevent biological degradation.

In addition, the textile fabric 18 can contain additives, such as a colorant (e.g., pigments, dyes, and tints), an antistatic agent, a brightening agent, a nucleating agent, an antioxidant, a UV stabilizer, a filler, and/or a lubricant, for example.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric 18 can have a basis weight ranging from 10 gsm to 500 gsm. In another example, the textile fabric 18 can have a basis weight ranging from 50 gsm to 400 gsm. In other examples, the textile fabric 18 can have a basis weight ranging from 100 gsm to 300 gsm, from 75 gsm to 250 gsm, from 125 gsm to 300 gsm, or from 150 gsm to 350 gsm.

The textile fabric 18 may be any color, and in an example is a color other than white (e.g., black, grey, etc.).

Printing Method and System

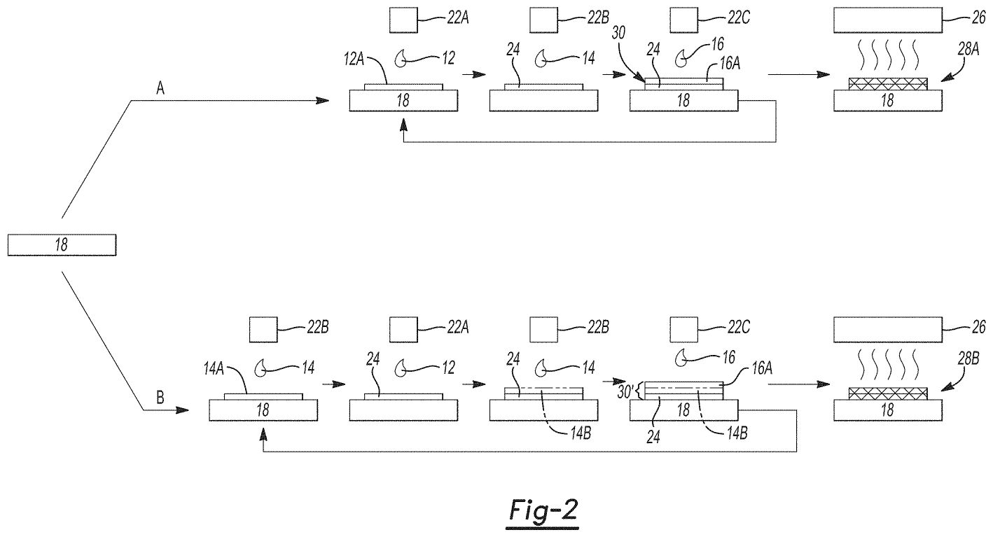

The printing method disclosed herein includes inkjet printing the colorless pre-treatment fluid 12 on the textile fabric 18 (to generate a pre-treatment fluid layer 12A, as shown in FIG. 2); inkjet printing the colorless fixer fluid 14 on the colorless pre-treatment fluid (e.g., layer 12A), thereby forming a mixed fluid layer 24 on the textile fabric 18; inkjet printing a white inkjet ink 16 on the mixed fluid layer 24; and thermally curing the textile fabric 18 having the mixed fluid layer 24 (FIG. 2) and the white inkjet ink 16 thereon, thereby generating a print 28A, 28B. In the examples disclosed herein, it is desirable for the fixer fluid 14 to be in contact with both the pre-treatment fluid 12 and the white inkjet ink 16. The print modes shown in FIG. 2 depict two examples for achieving the desired contact between the fluids 12, 14, and the ink 16. In FIG. 2, each printing mode is identified as an individual route, namely route A and route B. The printing method involves the formation of the mixed fluid layer on the textile fabric 18, and the various routes A, B depict a variety of ways to generate the mixed layer, and the final print 28A, 28B.

It is to be understood that any example of the pre-treatment fluid 12, the fixer fluid 14, and the white inkjet ink 16 may be used in the examples of the method. Further, it is to be understood that any example of the textile fabric 18 may be used in the examples of the method.

In both routes A, B of the printing method, the fluids 12, 14 and the ink 16 are printed at ambient temperature. In other words, the textile fabric 18 is maintained at a temperature ranging from about 18° C. to about 25° C. during printing. The mixed film 24 is formed when the pre-treatment fluid 12 and the fixer fluid 14 come in contact with each other on the textile fabric 18.

The pre-treatment fluid 12 is applied to the textile fabric 18, either directly or indirectly. When directly applied, the pre-treatment fluid 12 is the first of the fluids that is applied to the textile fabric 18 (see route A). When indirectly applied, the fixer fluid 14 is applied prior to the pre-treatment fluid 12 (see route B). The application of the pre-treatment fluid 12 may be accomplished via piezoelectric inkjet printing, or via thermal inkjet printing.

The fixer fluid 14 is applied to the textile fabric 18, either directly or indirectly. When directly applied, the fixer fluid 14 is the first of the fluids that is applied to the textile fabric 18 (see route B). When indirectly applied, the pre-treatment fluid 12 is applied prior to the fixer fluid 14 (see route A). The application of the fixer fluid 14 may be accomplished via piezoelectric inkjet printing, or via thermal inkjet printing.

The pre-treatment fluid 12 and the fixer fluid 14 form a mixed layer 24. In some examples, forming the mixed layer 24 involves i) inkjet printing the pre-treatment fluid 12 directly on the area of the textile fabric 18; and inkjet printing the fixer fluid 14 on the pre-treatment fluid 12 (see route A); or ii) inkjet printing the fixer fluid 14 directly on the area of the textile fabric 18; and inkjet printing the pre-treatment fluid 12 on the fixer fluid 14 (see route B). In route B, because it is desirable for the fixer fluid 14 to be in direct contact with the white inkjet ink 16, the fixer fluid 14 is applied both before and after the pre-treatment fluid 12.

The white inkjet ink 16 is applied to the textile fabric 18 after the application of each of the pre-treatment fluid 12 and the fixer fluid 14. The application of the white inkjet ink 16 may be accomplished via piezoelectric inkjet printing, or via thermal inkjet printing.

Because inkjet printing is used, the pretreatment fluid 12, the fixer fluid 14, and the white inkjet ink 16 may be selectively applied to the textile fabric 18. The pretreatment fluid 12, the fixer fluid 14, and the white inkjet ink 16 may be applied on areas of the textile fabric 18 where it is desirable to form the print 28A, 28B. In these examples, area(s) of the textile fabric 18 where it is not desirable to form the print 28A, 28B may remain exposed (i.e., not have any of the fluids 12, 14 or the ink 16 applied thereon).

The various fluids may be applied in multiple passes, and thus the following amounts encompass the total amount of the individual fluid 12, 14, 16 that is applied to form the print 28A, 28B. In an example, the pre-treatment fluid 12 is applied in an amount ranging from about 30 gsm (grams per square meter, when wet) to about 200 gsm. In another example, the pre-treatment fluid 12 is applied in an amount ranging from about 85 gsm to about 100 gsm. The amount of fixer fluid 14 that is applied depends upon the amount of white inkjet ink 16 that is to be applied. In some examples, the fixer fluid 14 is applied in an amount ranging from about 10 gsm to about 100 gsm. In other examples, the fixer fluid 14 is applied in an amount ranging from about 15 gsm to about 60 gsm. The white inkjet ink 16 is applied in an amount ranging from about 40 gsm to about 400 gsm. In another example, the white inkjet ink 16 is applied in an amount ranging from about 45 gsm to about 200 gsm.

Referring specifically to route A in FIG. 2, forming the image 28A involves inkjet printing the pre-treatment fluid 12 directly on the area of the textile fabric 18, and inkjet printing the fixer fluid 14 on the pre-treatment fluid 12. An applicator 22A is used to inkjet print the pre-treatment fluid 12 on a desired area of the textile fabric 18. The applicator 22A (and any of the applicators 22B, 22C disclosed herein) may be a thermal inkjet applicator or a piezoelectric inkjet applicator. The inkjet applicator may be a cartridge or pen including, e.g., a reservoir, a droplet generator (e.g., resistor, piezoelectric actuator), and a plurality of nozzles.

As shown in route A, a layer 12A of the pre-treatment fluid 12 is deposited on the desired area of the textile fabric 18. Then, the fixer fluid 14 is deposited on the layer 12A to form the mixed layer 24. The pre-treatment fluid 12 and the fixer fluid 14 are applied sequentially, one immediately after the other as the applicators 22A, 22B pass over the textile fabric 18. As such, the fixer fluid 14 is printed onto the pre-treatment fluid 12 while the pre-treatment fluid layer 12A is wet. Wet-on-wet printing is desirable in the examples disclosed herein so that the fluids 12, 14 intermingle to form the mixed layer 24, and because the printing workflow is simplified without the additional drying. In an example of wet-on-wet printing, the fixer fluid 14 is printed onto the pre-treatment fluid 12 within a period of time ranging from about 0.01 second to about 30 seconds after the pre-treatment fluid 12 is printed. Wet-on-wet printing may be accomplished in a single pass.

When the two fluids 12, 14 come into contact on the surface of the textile fabric 18, they intermingle to form the mixed layer 24. The mixed layer 24 has a viscosity that is higher than the viscosity of each of the individual fluids 12, 14. The mixed layer 24 forms a film on the surface of the textile fabric 18 that blocks pores of the textile fabric 18.

Once the mixed layer 24 is formed, the white inkjet ink 16 is deposited on the mixed layer 24. The deposited white inkjet ink 16 forms an ink layer 16A on the mixed layer 24. The combination of the mixed layer 24 and the ink layer 16A forms a stack 30. Because the mixed layer 24 forms a film, the pigment of the ink layer 16A is located at or near the surface of the textile fabric 18, which ultimately contributes to improved opacity of the white image 28A that is formed.

The processes involved in forming the stack 30 may be repeated as many times as desired to create multiple stacks 30 on the textile fabric 18. Multiple stacks 30 may contribute to increased opacity. To form a second stack on the first stack 30, the pre-treatment fluid 12 is inkjet printed onto the stack 30, the fixer fluid 14 is inkjet printed onto the additional layer of pre-treatment fluid 12 to form a second mixed layer, and the white inkjet ink 16 is inkjet printed onto the second layer mixed layer. It is to be understood that any desired number of stacks 30 may be generated, and in one example, the process is repeated six times to generate six stacks 30 on the textile fabric 18.

Once a desired number of stacks 30 is formed, the example shown in route A then involves thermally curing the textile fabric 18 having the stack(s) 30 thereon. This generates the white print 28A (shown in FIG. 2, route A). The thermal curing may be accomplished by applying heat to the textile fabric 18. Heating may be performed using any suitable heating mechanism 26, such as a heat press, oven, etc., that is capable of convection heating, air-draft, radiant heat, infrared heating, etc. The heat generated is sufficient to initiate crosslinking or other interactions that bind the pigment onto the textile fabric 18. In an example, the thermal curing the textile fabric 18 (having the stack(s) 30 thereon) involves heating at a temperature ranging from about 80° C. to about 200° C. for a time ranging from about 5 seconds to about 10 minutes. In another example, the temperature ranges from about 100° C. to about 180° C. In still another example, thermal curing is achieved by heating the textile fabric 18 to a temperature of 150° C. for about 3 minutes.

Pressure may also be applied during thermal curing. The pressure applied to the textile fabric 18 (with the stack(s) 30 thereon) ranges from about 0.1 atm to about 8 atm.

Route B in FIG. 2 illustrates another example printing mode.

The example printing mode of route B involves inkjet printing a first layer 14A of the colorless fixer fluid 14 on the textile fabric 18 before inkjet printing the colorless pre-treatment fluid 12. In this example, an applicator 22B is used to inkjet print the fixer fluid 14 on a desired area of the textile fabric 18 to form the layer 14A. Then, the pre-treatment fluid 12 is deposited on the layer 14A to form the mixed layer 24. Then, a second layer 14B of the fixer fluid 14 is formed by inkjet printing the fixer fluid 14 on the mixed layer 24. In these examples, the fixer fluid 14 is used to generate both the first layer 14A and the second layer 14B. As such, the same applicator 22B is used to form both of the layers 14A, 14B.

While the second fixer fluid layer 14B is shown as being separate from the mixed layer 24, it is to be understood that some of the fixer fluid components may intermingle with components in the mixed layer 24 to further increase the viscosity of the mixed layer 24. The application of the second fixer fluid layer 14B is desirable so that the cationic polymer of the fixer fluid 14 in close contact with the pigment of the white inkjet ink 16 for fixing the pigment at the surface of the textile fabric 18. The additional layer 14B of the fixer fluid 14 may contribute to increased opacity in the final print 28B as it may contribute to an increased amount of immobilized white pigment.

Once the mixed layer 24 is formed and the second fixer fluid layer 14 is applied, the white inkjet ink 16 is deposited on the mixed layer 24. The deposited white inkjet ink 16 forms an ink layer 16A on the mixed layer 24. The combination of the mixed layer 24 and the ink layer 16A forms a stack 30′. As described herein, this stack 30′ may also include a separate layer 14B, depending upon the interaction of the second fixer fluid 14 at the surface of the mixed layer 24. The mixed layer 24 forms a film that blocks pores of the textile fabric 18 and the separate layer 14B provides additional cationic polymer at the interface with the white inkjet ink 16, and thus the pigment of the ink layer 16A is located at or near the surface of the textile fabric 18, which ultimately contributes to improved opacity of the white image 28B that is formed.

The processes involved in forming the stack 30′ may be repeated as many times as desired to create multiple stacks 30′ on the textile fabric 18. Multiple stacks 30′ may contribute to increased opacity. To form a second stack on the first stack 30′, the fixer fluid 14 is inkjet printed onto the stack 30′, and then the following fluids are printed sequentially onto the newly formed fixer fluid layer: the pre-treatment fluid 12, the fixer fluid 14, and the white inkjet ink 16. It is to be understood that any desired number of stacks 30′ may be generated, and in one example, the process is repeated six times to generate six stacks 30′ on the textile fabric 18.

Once a desired number of stacks 30′ is formed, the example shown in route B then involves thermally curing the textile fabric 18 having the stack(s) 30′ thereon. This generates the white print 28B (shown in FIG. 2, route B). The thermal curing may be accomplished by applying heat or heat and pressure to the textile fabric 18 using the heating mechanism 26 as described in reference to route A.

In the example of route B, wet-on-wet-on-wet-on-wet printing is used. This type of printing is desirable in the examples disclosed herein so that the fluids 12, 14 intermingle to form the mixed layer 24, and because the printing workflow is simplified without the additional drying. The respective fluids (14, 12, 14, 16) are deposited within a period of time ranging from about 0.01 second to about 30 seconds after the preceding fluid is printed. Wet-on-wet-on-wet-on-wet printing may be accomplished in a single pass.

To further illustrate the present disclosure, examples are given herein. It is to be understood that these examples are provided for illustrative purposes and are not to be construed as limiting the scope of the present disclosure.

### EXAMPLES

### Example 1

Fifteen different pre-treatment fluids were prepared as described herein. Some were prepared with different examples of aliphatic polyester-polyurethanes; some were prepared with an aromatic polyester-polyurethane; one was prepared with an acrylic copolymer; and some were prepared with a polyether-polyurethane.

Table 1 sets forth the various polymeric binders that were used. The details regarding the preparation of Binder A is below Table 1.

TABLE 1
Polymeric Binders

| Polymeric Binder ID | Binder Description |
|---|---|
| Binder A | Aliphatic polyester-polyurethane with |
| | sulfonic groups and no carboxylic |
| | groups |
| Binder B | TUBIFAST ™ AS 5087 FF |
| | (polyacrylate) |
| Binder C | DISPERCOLL ® U42 |
| | (aromatic polyester-polyurethane) |
| Binder D | IMPRANIL ® DLN-SD |
| | (aliphatic polyester-polyurethane) |
| Binder E | IMPRANIL ® LP DSB 1068 |
| | (polyether-polyurethane) |

Binder A was prepared as follows:

72.6 g of polyester polyol (STEPANOL® PC-1015-55), and 20.6 g of isophorone diisocyanate (IPDI) in 80 g of acetone were mixed in a 500 ml 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. About 0.5 g samples were withdrawn for % NCO titration to confirm the reaction. The measured NCO value was 5.10%. Theoretical % NCO should be 5.13%.

The polymerization temperature was reduced to 50° C. 3.8 g of 2,2,4-trimethylhexane-1,6-diamine (TMD), 5.9 g of sodium aminoalklysulphonate (A-95, 50% in water) and about 14.8 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. Stirring was continued for about 30 minutes at 50° C. Then, about 201.7 g of cold deionized water was added to polymer mixture in a 4-neck round bottom flask over 10 minutes with good agitation to form the sulfonated only polyurethane binder dispersion. The agitation was continued for 60 minutes at 50° C. The sulfonated only polyurethane binder dispersion was filtered through 400 mesh stainless sieve. Acetone was removed with rotorvap at 50° C. (added 2 drops (20 mg) BYK-011 de-foaming agent to control foaming). The final sulfonated only polyurethane binder dispersion was filtered through fiber glass filter paper. The D50 particle size measured by Malvern Zetasizer was 156.8 nm. The pH was 7.0. The solid content was 34.5%.

Some of the pre-treatment fluids were prepared with different vehicles. Table 2 sets forth the various vehicles that were used, and all percentages represent the wt % active in the vehicle.

TABLE 2
Pre-treatment Vehicles

| Component | | Vehicle | Vehicle | Vehicle |
|---|---|---|---|---|
| Type | Specific Component | A | B | C |
| Co-Solvent | 1,3-propanediol | 9 | n/a | n/a |
| Anti-Decel Agent | LEG-1 | 1 | n/a | n/a |
| Surfactant | BYK ® 348 | 0.2 | n/a | 0.2 |
| Anti-Microbial | ACTICIDER B20 | 0.22 | n/a | n/a |
| Agent | | | | |
| Water | Deionized water | 89.58 | 100 | 99.8 |

The pre-treatment fluids were prepared by combining one of the binders from Table 1 with one of the pre-treatment vehicles from Table 2. The formulation of each of the pre-treatment fluids is shown in Table 3.

TABLE 3
Pre-treatment Fluid Formulations

| | | Binder | | PT Vehicle |
|---|---|---|---|---|
| PT ID | Binder ID | Wt % active | PT Vehicle ID | Wt % |
| PT 1 | Binder A | 6 | Vehicle A | 94 |
| PT 2 | Binder A | 8 | Vehicle A | 92 |
| PT 3 | Binder A | 10 | Vehicle A | 90 |
| PT 4 | Binder B | 10 | Vehicle A | 90 |
| PT 5 | Binder C | 10 | Vehicle A | 90 |
| PT 6 | Binder D | 6 | Vehicle A | 94 |
| PT 7 | Binder D | 7 | Vehicle A | 93 |
| PT 8 | Binder D | 10 | Vehicle A | 90 |
| PT 9 | Binder E | 10 | Vehicle A | 90 |
| PT 10 | Binder A | 10 | Vehicle B | 90 |
| PT 11 | Binder A | 10 | Vehicle C | 90 |
| PT 12 | Binder C | 10 | Vehicle B | 90 |
| PT 13 | Binder C | 10 | Vehicle C | 90 |
| PT 14 | Binder E | 10 | Vehicle B | 90 |
| PT 15 | Binder E | 10 | Vehicle C | 90 |

A fixer fluid and a white inkjet ink were also used in this example. The formulations are listed below in Tables 4 and 5.

TABLE 4
Fixer Fluid

| Ingredient | Specific Component | wt % active |
|---|---|---|
| Co-solvent | 2,2-dimethyl-1,3-propanediol | 4 |
| Cationic polymer | POLYCUP ™ 7360A | 4 |
| Non-ionic surfactant | SURFYNOL ® 440 | 0.3 |
| Anti-kogation agent | CRODAFOS ® N10A | 0.25 |
| | CRODAFOS ® N3A | 0.25 |
| Water | Deionized water | Balance |

TABLE 5
White Inkjet Ink

| Ingredient | Specific Component | wt % active |
|---|---|---|
| Pigment dispersion | White pigment | 10 |
| | dispersion | |
| Co-solvent | 1,3-propanediol | 12 |
| Non-ionic surfactant | SURFYNOL ® 440 | 0.3 |
| Binder dispersion | Binder A | 10 |
| Anti-decel agent | LIPONIC ® EG-1 | 2 |
| Anti-microbial agent | ACTICIDER B20 | 0.04 |
| Rheology modifier | Boehmite | 0.3 |
| Water | Deionized water | Balance |

Binder Comparison

Prints were generated using PT 1 through PT 8 (each of which had the same vehicle) to compare the different binders. Two comparative prints were generated without any pre-treatment fluid, but with the fixer fluid and the white inkjet ink. The example prints were generated with one of PT 1 through PT 8, the fixer fluid, and the white inkjet ink. Gildan black midweight 780 cotton T-shirts were used as the textile fabric.

For the example prints (1-10), the pre-treatment fluids were respectively sandwiched between the fixer fluid (i.e., fixer fluid was printed before and after the pre-treatment fluid). Comparative print 1 included alternating layers of the fixer fluid and white inkjet ink without any pre-treatment fluid, and comparative print 2 included a repeated sequence of two layers of fixer fluid and a layer of the white inkjet ink.

Table 6 sets forth the fluids that were used to generate the various prints, the order in which the fluids were printed (i.e., the printing sequence), and the amount of fluid that was dispensed in each printing pass. Each of the fluids was inkjet printed using an 11 ng thermal inkjet printhead and wet-on-wet printing. The printing sequence was repeated 6 times for each example and comparative example.

TABLE 6
Print Condition and Components

| | First fluid | Second fluid | Third fluid | Fourth fluid |
|---|---|---|---|---|
| Print | printed | printed | printed | printed |
| sample | (gsm) | (gsm) | (gsm) | (gsm) |
| Comp. Print 1 | N/A | N/A | Fixer fluid | White inkjet ink |
| | | | (9.16 gsm) | (50 gsm) |
| Comp. Print 2 | Fixer fluid | N/A | Fixer fluid | White inkjet ink |
| | (9.16 gsm) | | (9.16 gsm) | (50 gsm) |
| Ex. Print 3 | Fixer fluid | PT 1 | Fixer fluid | White inkjet ink |
| | (9.16 gsm) | (50 gsm) | (9.16 gsm) | (50 gsm) |
| Ex. Print 4 | Fixer fluid | PT 2 | Fixer fluid | White inkjet ink |
| | (9.16 gsm) | (50 gsm) | (9.16 gsm) | (50 gsm) |
| Ex. Print 5-1 | Fixer fluid | PT 3 | Fixer fluid | White inkjet ink |
| | (9.16 gsm) | (50 gsm) | (9.16 gsm) | (50 gsm) |
| Ex. Print 5-2 | Fixer fluid | PT 3 | Fixer fluid | White inkjet ink |
| | (9.16 gsm) | (50 gsm) | (9.16 gsm) | (50 gsm) |
| Ex. Print 6-1 | Fixer fluid | PT 4 | Fixer fluid | White inkjet ink |
| | (9.16 gsm) | (50 gsm) | (9.16 gsm) | (50 gsm) |
| Ex. Print 6-2 | Fixer fluid | PT 4 | Fixer fluid | White inkjet ink |
| | (9.16 gsm) | (50 gsm) | (9.16 gsm) | (50 gsm) |
| Ex. Print 7 | Fixer fluid | PT 5 | Fixer fluid | White inkjet ink |
| | (9.16 gsm) | (50 gsm) | (9.16 gsm) | (50 gsm) |
| Ex. Print 8 | Fixer fluid | PT 6 | Fixer fluid | White inkjet ink |
| | (9.16 gsm) | (50 gsm) | (9.16 gsm) | (50 gsm) |
| Ex. Print 9 | Fixer fluid | PT 7 | Fixer fluid | White inkjet ink |
| | (9.16 gsm) | (50 gsm) | (9.16 gsm) | (50 gsm) |
| Ex. Print 10-1 | Fixer fluid | PT 8 | Fixer fluid | White inkjet ink |
| | (9.16 gsm) | (50 gsm) | (9.16 gsm) | (50 gsm) |
| Ex. Print 10-2 | Fixer fluid | PT 8 | Fixer fluid | White inkjet ink |
| | (9.16 gsm) | (50 gsm) | (9.16 gsm) | (50 gsm) |
| Ex. Print 10-3 | Fixer fluid | PT 8 | Fixer fluid | White inkjet ink |
| | (9.16 gsm) | (50 gsm) | (9.16 gsm) | (50 gsm) |

After all of the fluids were applied, the textile fabrics were thermally cured to generate the respective example and comparative example prints. The thermal curing was performing using a heat press set at 150° C. for about 3 minutes.

The example and comparative prints were tested for opacity, in terms of L*, i.e., lightness, of the white print. After the initial L* measurements were taken, each example and comparative print was washed 5 times in a Whirlpool Washer (Model WTW5000DW) with warm water (at about 40° C.) and detergent and the following settings: soil level=medium; normal wash; 1 rinse. Each example and comparative print was allowed to air dry between each wash. Then, the L* value of each example and comparative print was measured after the 5 washes. ΔL* was calculated by subtracting the L* taken after the 5 washed from the L* taken before the 5 washed.

The example and comparative prints were also tested for washfastness. For the washfastness test, the L*a*b* values of a color (e.g., white) before and after the 5 washes were measured. L* is lightness (as noted above), a* is the color channel for color opponents green-red, and b* is the color channel for color opponents blue-yellow. After the initial L*a*b* measurements were taken, each example print and the comparative example print was washed 5 times as described above. Then, the L*a*b* values of each example and comparative print were measured after the 5 washes. ΔE₇₆ was calculated using the CIEDE1976 color-difference formula, which is based on the CIELAB color space. Given a pair of color values in CIELAB space L*₁,a*₁,b*₁ and L*₂,a*₂,b*₂, the CIEDE1976 color difference between them is as follows:

ΔE₇₆=\sqrt{[(L₂*−L₁*)²+(a₂*−a₁*)²+(b₂*−b₁*)²]}

All L*a*b* (D50/2) measurements were taken with an X-Rite color measurement instrument. The results are shown in Table 7.

TABLE 7
Opacity and Washfastness

| | Before Wash | | | After 5 Washes | | | | |
|---|---|---|---|---|---|---|---|---|
| Print sample | L* | a* | b* | L* | a* | b* | ΔL* | ΔE₇₆ |
| Comp. Print 1 | 85.1 | −2.2 | −4.5 | 85.0 | −2.1 | −4.1 | −0.1 | 0.5 |
| Comp. Print 2 | 85.4 | −2.2 | −3.9 | 84.6 | −2.1 | −3.7 | −0.7 | 0.8 |
| Ex. Print 3 | 91.8 | −1.5 | −2.0 | 92.4 | −1.6 | −2.2 | 0.5 | 0.6 |
| Ex. Print 4 | 91.6 | −1.5 | −1.9 | 92.0 | −1.5 | −2.0 | 0.4 | 0.5 |
| Ex. Print 5-1 | 91.6 | −1.6 | −1.3 | 91.6 | −1.6 | −1.9 | 0.1 | 0.6 |
| Ex. Print 5-2 | 91.1 | −1.5 | −2.0 | 91.5 | −1.6 | −2.2 | 0.4 | 0.4 |
| Ex. Print 6-1 | 90.3 | −1.7 | −2.5 | 89.7 | −1.8 | −2.9 | −0.6 | 0.7 |
| Ex. Print 6-2 | 90.8 | −1.6 | −1.9 | 92.0 | −1.5 | −1.9 | 1.2 | 1.2 |
| Ex. Print 7 | 91.4 | −1.5 | −2.0 | 91.9 | −1.5 | −2.0 | 0.5 | 0.5 |
| Ex. Print 8 | 88.9 | −1.8 | −3.0 | 88.2 | −1.9 | −3.1 | −0.7 | 0.7 |
| Ex. Print 9 | 87.4 | −1.9 | −3.3 | 87.4 | −1.9 | −3.3 | 0.1 | 0.1 |
| Ex. Print | 88.3 | −1.9 | −3.3 | 86.7 | −1.9 | −3.3 | −1.7 | 1.7 |
| 10-1 | | | | | | | | |
| Ex. Print | 87.7 | −1.9 | −3.3 | 86.3 | −2.0 | −3.6 | −1.3 | 1.4 |
| 10-2 | | | | | | | | |
| Ex. Print | 88.4 | −1.8 | −2.9 | 86.8 | −1.9 | −3.2 | −1.5 | 1.6 |
| 10-3 | | | | | | | | |

The example prints had improved initial white opacity compared to each of the comparative prints, regardless of the binder used or the amount of binder used. The example prints each had an initial L* (before washing) that was at least 2.3 higher than Comp. Print 1, which had the lowest initial L* and was printed without any pre-treatment fluid. The example prints exhibited comparable washfastness in terms of both the change in opacity (ΔL*) and ΔE₇₆ relative to the comparative prints.

Photographs of Comp. Print 2, Ex. Print 5-1 and Ex. Print 7 were taken before washing and after the 5 washes. These photographs are reproduced herein in black and white in FIG. 3A through FIG. 5B. Comp. Print 2 before washing is shown in FIG. 3A and after washing is shown FIG. 3B. Ex. Print 5-1 before washing is shown in FIG. 4A and after washing is shown in FIG. 4B. Ex. Print 7 before washing is shown in FIG. 5A and after washing is shown in FIG. 5B. The images corresponded with the quantitative L* values, illustrating an improvement in opacity for each of the example prints as compared to the comparative print. The example prints were more opaque and less prone to fading after the washfastness test.

Comparison of Pre-Treatment Fluid and No Pre-Treatment Fluid

Additional prints were also generated to compare examples of the pre-treatment fluid described herein with a comparative pre-treatment fluid. The example prints were generated using PT 3 (10 wt % Binder A/Vehicle A) and PT 9 (10 wt % Binder E/Vehicle A) and were compared with two additional comparative examples. One comparative print was generated without any pre-treatment fluid, but with the fixer fluid and the white inkjet ink. Another comparative print was generated with a pre-treatment fluid consisting of Vehicle A and no polymeric binder, the fixer fluid, and the white inkjet ink. The example prints were generated with either PT 3 or PT 9, the fixer fluid, and the white inkjet ink. Gildan soft style ring spun 64000 black cotton T-shirts were used as the textile fabric.

For the example prints (13 and 14), the pre-treatment fluids were respectively sandwiched between the fixer fluid (i.e., fixer fluid was printed before and after the pre-treatment fluid). Comparative print 11 included a repeated sequence of two layers of fixer fluid and a layer of the white inkjet ink. For comparative print 12, the comparative pre-treatment fluid was sandwiched between the fixer fluid (i.e., fixer fluid was printed before and after the pre-treatment fluid).

Table 8 sets forth the fluids that were used to generate the various prints, the order in which the fluids were printed (i.e., the printing sequence), and the amount of fluid that was dispensed in each printing pass. Each of the fluids was inkjet printed using an 11 ng thermal inkjet printhead and wet-on-wet printing. The printing sequence was repeated 6 times for each example and comparative example.

TABLE 8
Print Condition and Components

| | First fluid | Second fluid | Third fluid | Fourth fluid |
|---|---|---|---|---|
| Print | printed | printed | printed | printed |
| sample | (gsm) | (gsm) | (gsm) | (gsm) |
| Comp. Print 11 | Fixer fluid | N/A | Fixer fluid | White inkjet ink |
| | (9.16 gsm) | | (9.16 gsm) | (50 gsm) |
| Comp. Print 12 | Fixer fluid | Comp. PT | Fixer fluid | White inkjet ink |
| | (9.16 gsm) | (50 gsm) | (9.16 gsm) | (50 gsm) |
| Ex. Print 13 | Fixer fluid | PT 3 | Fixer fluid | White inkjet ink |
| | (9.16 gsm) | (50 gsm) | (9.16 gsm) | (50 gsm) |
| Ex. Print 14 | Fixer fluid | PT 9 | Fixer fluid | White inkjet ink |
| | (9.16 gsm) | (50 gsm) | (9.16 gsm) | (50 gsm) |

After all of the fluids were applied, the textile fabrics were thermally cured to generate the respective example and comparative example prints. The thermal curing was performing using a heat press set at 150° C. for about 3 minutes.

The additional example and comparative prints were tested for initial L*, i.e., lightness, of the white print. The results are shown in Table 9.

TABLE 9
Initial L*

| | Before Wash | | |
|---|---|---|---|
| Print sample | L* | a* | b* |
| Comp. Print 11 | 86.1 | −2.1 | −3.9 |
| Comp. Print 12 | 84.5 | −2.2 | −4.3 |
| Ex. Print 13 | 91.4 | −1.6 | −2.2 |
| Ex. Print 14 | 91.3 | −1.6 | −2.1 |

The example prints had improved initial white opacity compared to each of the comparative prints, including Comp. Print 12 printed with the comparative pre-treatment fluid. Both Binder A and Binder E improved the initial L* relative to Comp. Print 11 by about 5.

Vehicle Comparison

Additional prints (15-22) were generated using PT 3, PT 5, and PT 10 through PT 15 (some of which had different vehicles) to compare the different vehicles. These additional prints were compared with Comp. Print 11. The example prints were generated with the respective pre-treatment fluid, the fixer fluid, and the white inkjet ink. Gildan soft style ring spun 64000 black cotton T-shirts were used as the textile fabric.

For the example prints (15-22), the pre-treatment fluids were respectively sandwiched between the fixer fluid (i.e., fixer fluid was printed before and after the pre-treatment fluid). As described above comparative print 11 included a repeated sequence of two layers of fixer fluid and a layer of the white inkjet ink.

Table 10 sets forth the fluids that were used to generate the various prints, the order in which the fluids were printed (i.e., the printing sequence), and the amount of fluid that was dispensed in each printing pass. Each of the fluids was inkjet printed using an 11 ng thermal inkjet printhead and wet-on-wet printing. The printing sequence was repeated 6 times for each example and comparative example.

TABLE 10
Print Condition and Components

| | First fluid | Second fluid | Third fluid | Fourth fluid |
|---|---|---|---|---|
| Print | printed | printed | printed | printed |
| sample | (gsm) | (gsm) | (gsm) | (gsm) |
| Comp. Print 11 | Fixer fluid | N/A | Fixer fluid | White inkjet ink |
| | (9.16 gsm) | | (9.16 gsm) | (50 gsm) |
| Ex. Print 15 | Fixer fluid | PT 10 | Fixer fluid | White inkjet ink |
| | (9.16 gsm) | (50 gsm) | (9.16 gsm) | (50 gsm) |
| Ex. Print 16 | Fixer fluid | PT 3 | Fixer fluid | White inkjet ink |
| | (9.16 gsm) | (50 gsm) | (9.16 gsm) | (50 gsm) |
| Ex. Print 17 | Fixer fluid | PT 11 | Fixer fluid | White inkjet ink |
| | (9.16 gsm) | (50 gsm) | (9.16 gsm) | (50 gsm) |
| Ex. Print 18 | Fixer fluid | PT 12 | Fixer fluid | White inkjet ink |
| | (9.16 gsm) | (50 gsm) | (9.16 gsm) | (50 gsm) |
| Ex. Print 19 | Fixer fluid | PT 5 | Fixer fluid | White inkjet ink |
| | (9.16 gsm) | (50 gsm) | (9.16 gsm) | (50 gsm) |
| Ex. Print 20 | Fixer fluid | PT 13 | Fixer fluid | White inkjet ink |
| | (9.16 gsm) | (50 gsm) | (9.16 gsm) | (50 gsm) |
| Ex. Print 21 | Fixer fluid | PT 14 | Fixer fluid | White inkjet ink |
| | (9.16 gsm) | (50 gsm) | (9.16 gsm) | (50 gsm) |
| Ex. Print 22 | Fixer fluid | PT 15 | Fixer fluid | White inkjet ink |
| | (9.16 gsm) | (50 gsm) | (9.16 gsm) | (50 gsm) |

After all of the fluids were applied, the textile fabrics were thermally cured to generate the respective example and comparative example prints. The thermal curing was performing using a heat press set at 150° C. for about 3 minutes.

The additional example and comparative prints were tested for opacity and washfastness as described herein. The results are shown in Table 11.

TABLE 11
Opacity and Washfastness

| | Before Wash | | | After 5 Washes | | | | |
|---|---|---|---|---|---|---|---|---|
| Print sample | L* | a* | b* | L* | a* | b* | ΔL* | ΔE₇₆ |
| Comp. Print 11 | 86.1 | −2.1 | −3.9 | 88.2 | −1.9 | −3.6 | 2.1 | 2.1 |
| Ex. Print 15 | 89.5 | −1.8 | −2.9 | 89.8 | −1.8 | −3.2 | 0.3 | 0.5 |
| Ex. Print 16 | 92.2 | −1.5 | −1.9 | 92.7 | −1.4 | −2.2 | 0.5 | 0.6 |
| Ex. Print 17 | 93.1 | −1.4 | −1.6 | 93.5 | −1.3 | −1.8 | 0.4 | 0.4 |
| Ex. Print 18 | 86.2 | −2.1 | −3.8 | 86.7 | −2.0 | −4.1 | 0.5 | 0.6 |
| Ex. Print 19 | 91.1 | −1.6 | −2.3 | 91.4 | −1.5 | −2.5 | 0.3 | 0.4 |
| Ex. Print 20 | 91.4 | −1.6 | −2.3 | 91.3 | −1.6 | −2.7 | 0.0 | 0.4 |
| Ex. Print 21 | 84.7 | −2.2 | −4.3 | 85.8 | −2.1 | −4.2 | 1.1 | 1.1 |
| Ex. Print 22 | 91.4 | −1.6 | −2.2 | 89.7 | −1.6 | −2.8 | −1.7 | 1.8 |

The example prints with generated with PT 3, PT 11, PT 5, PT 13, and PT 15 (each of which included the surfactant) had improved initial white opacity compared to Comp. Print 11 printed with the comparative pre-treatment fluid. Ex. Print 18 generated with Binder B and vehicle B (water only) exhibited slightly better initial L* than Comp. Print 11, and Ex. Print 21 generated with Binder E and vehicle B (water only) exhibited slightly worse initial L* than Comp. Print 11.

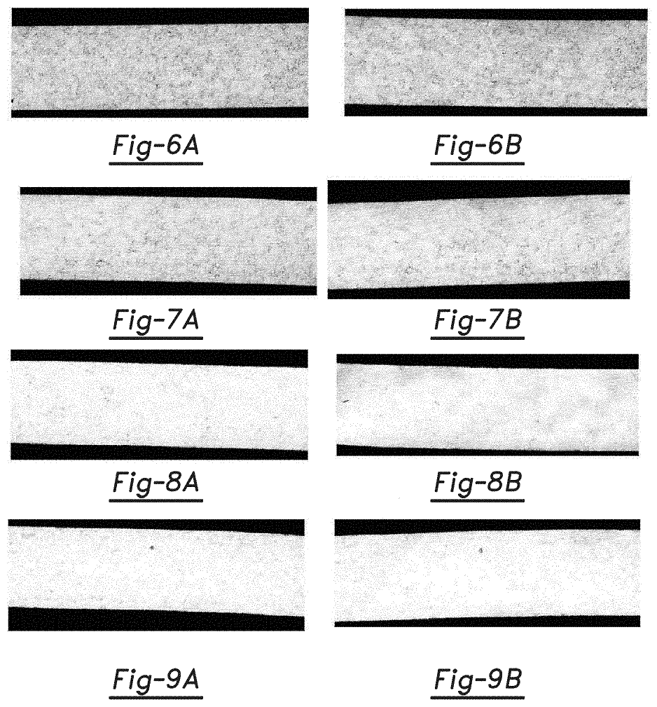

Photographs of Comp. Print 11, Ex. Print 15, Ex. Print 16, and Ex. Print 17 were taken before washing and after the 5 washes. These photographs are reproduced herein in black and white in FIG. 6A through FIG. 9B. Comp. Print 11 before washing is shown in FIG. 6A and after washing is shown FIG. 6B. Ex. Print 15 before washing is shown in FIG. 7A and after washing is shown in FIG. 7B. Ex. Print 16 before washing is shown in FIG. 8A and after washing is shown in FIG. 8B. Ex. Print 17 before washing is shown in FIG. 9A and after washing is shown in FIG. 9B. The images corresponded with the quantitative L* values, illustrating an improvement in opacity for these example prints as compared to the comparative print. These example prints were more opaque and less prone to fading after the washfastness test.

Heat Press Before Printing

Comp. Print 11, Ex. Print 17, Ex. Print 20, and Ex. Print 22 did not include any heat treatment prior to printing.

To compare the effect of a pre-printing heat treatment, additional prints (24-26 and 28) were generated using a pre-printing heat treatment, PT 11 (used to generate Ex. Print 17), PT 13 (used to generate example print 20), or PT 14 (used to generate Ex. Print 22), the fixer fluid, and the white inkjet ink. Two additional comparative prints (23 and 27) were generated using a pre-printing heat treatment, the fixer fluid, and the white inkjet ink, but without any pre-treatment fluid. Gildan soft style ring spun 64000 black cotton T-shirts were used as the textile fabric. All of these additional prints (23-28) were compared with Comp. Print 11, Ex. Print 17, Ex. Print 20, and Ex. Print 22.

Table 12 sets forth the pre-printing heat treatment, the fluids that were used to generate the various prints, the order in which the fluids were printed (i.e., the printing sequence), and the amount of fluid that was dispensed in each printing pass. Each of the fluids was inkjet printed using an 11 ng thermal inkjet printhead and wet-on-wet printing. The printing sequence was repeated 6 times for each example and comparative example. The information from Table 10 for Comp. Print 11, Ex. Print 17, Ex. Print 20, and Ex. Print 22 is reproduced in Table 12 for convenience.

TABLE 12
Print Condition and Components

| | Pre-Print | First fluid | Second fluid | Third fluid | Fourth fluid |
|---|---|---|---|---|---|
| Print | Heat | printed | printed | printed | printed |
| sample | Treatment | (gsm) | (gsm) | (gsm) | (gsm) |
| Comp. Print 11 | N/A | Fixer fluid | N/A | Fixer fluid | White inkjet ink |
| | | (9.16 gsm) | | (9.16 gsm) | (50 gsm) |
| Ex. Print 17 | N/A | Fixer fluid | PT 11 | Fixer fluid | White inkjet ink |
| | | (9.16 gsm) | (50 gsm) | (9.16 gsm) | (50 gsm) |
| Ex. Print 20 | N/A | Fixer fluid | PT 13 | Fixer fluid | White inkjet ink |
| | | (9.16 gsm) | (50 gsm) | (9.16 gsm) | (50 gsm) |
| Ex. Print 22 | N/A | Fixer fluid | PT 14 | Fixer fluid | White inkjet ink |
| | | (9.16 gsm) | (50 gsm) | (9.16 gsm) | (50 gsm) |
| Comp. Print 23 | Heat Press | Fixer fluid | N/A | Fixer fluid | White inkjet ink |
| | 150° C. | (9.16 gsm) | | (9.16 gsm) | (50 gsm) |
| | 1 min. | | | | |
| Ex. Print 24 | Heat Press | Fixer fluid | PT 11 | Fixer fluid | White inkjet ink |
| | 150° C. | (9.16 gsm) | (50 gsm) | (9.16 gsm) | (50 gsm) |
| | 1 min. | | | | |
| Ex. Print 25 | Heat Press | Fixer fluid | PT 13 | Fixer fluid | White inkjet ink |
| | 150° C. | (9.16 gsm) | (50 gsm) | (9.16 gsm) | (50 gsm) |
| | 1 min. | | | | |
| Ex. Print 26 | Heat Press | Fixer fluid | PT 14 | Fixer fluid | White inkjet ink |
| | 150° C. | (9.16 gsm) | (50 gsm) | (9.16 gsm) | (50 gsm) |
| | 1 min. | | | | |
| Comp. Print 27 | Heat Press | Fixer fluid | N/A | Fixer fluid | White inkjet ink |
| | 150° C. | (9.16 gsm) | | (9.16 gsm) | (50 gsm) |
| | 1 min. | | | | |
| Ex. Print 28 | Heat Press | Fixer fluid | PT 11 | Fixer fluid | White inkjet ink |
| | 150° C. | (9.16 gsm) | (50 gsm) | (9.16 gsm) | (50 gsm) |
| | 1 min. | | | | |

After all of the fluids were applied, the textile fabrics were thermally cured to generate the respective example and comparative example prints. Two different curing processes were used. For Comp. Print 23 and Ex. Prints 24-26, the thermal curing was performing using a heat press set at 150° C. for about 3 minutes. For Comp. Print 27 and Ex. Print 28, the thermal curing was performing using an oven set at 150° C. for about 3 minutes.

The additional example and comparative prints were tested for opacity and washfastness as described herein. The results are shown in Table 13. The information from Table 11 for Comp. Print 11, Ex. Print 17, Ex. Print 20, and Ex. Print 22 is reproduced in Table 13 for convenience.

TABLE 13
Opacity and Washfastness

| | Before Wash | | | After 5 Washes | | | | |
|---|---|---|---|---|---|---|---|---|
| Print sample | L* | a* | b* | L* | a* | b* | ΔL* | ΔE₇₆ |
| Comp. Print 11 | 86.1 | −2.1 | −3.9 | 88.2 | −1.9 | −3.6 | 2.1 | 2.1 |
| Ex. Print 17 | 93.1 | −1.4 | −1.6 | 93.5 | −1.3 | −1.8 | 0.4 | 0.4 |
| Ex. Print 20 | 91.4 | −1.6 | −2.3 | 91.3 | −1.6 | −2.7 | 0.0 | 0.4 |
| Ex. Print 22 | 91.4 | −1.6 | −2.2 | 89.7 | −1.6 | −2.8 | −1.7 | 1.8 |
| Comp. Print 23 | 88.1 | −2.0 | −3.6 | 88.2 | −1.9 | −3.7 | 0.1 | 0.2 |
| Ex. Print 24 | 94.1 | −1.3 | −1.2 | 93.5 | −1.3 | −1.7 | −0.6 | 0.8 |
| Ex. Print 25 | 92.5 | −1.6 | −2.0 | 92.1 | −1.5 | −2.5 | −0.4 | 0.6 |
| Ex. Print 26 | 91.8 | −1.6 | −2.1 | 91.4 | −1.5 | −2.6 | −0.5 | 0.7 |
| Comp. Print 27 | 86.4 | −2.1 | −3.7 | 83.6 | −1.9 | −4.2 | −2.8 | 2.9 |
| Ex. Print 28 | 93.2 | −1.3 | −1.2 | 93.1 | −1.2 | −2.0 | 0.0 | 0.8 |

The results for Ex. Prints 24-26 and 28 demonstrate that a pre-printing heat treatment may slightly improve the initial L*, compared to similar prints generated with the same pre-treatment fluid but without the pre-printing heat treatment. Ex. Print 28 exhibited high opacity and good washfastness, indicating that curing in an oven may be desirable.

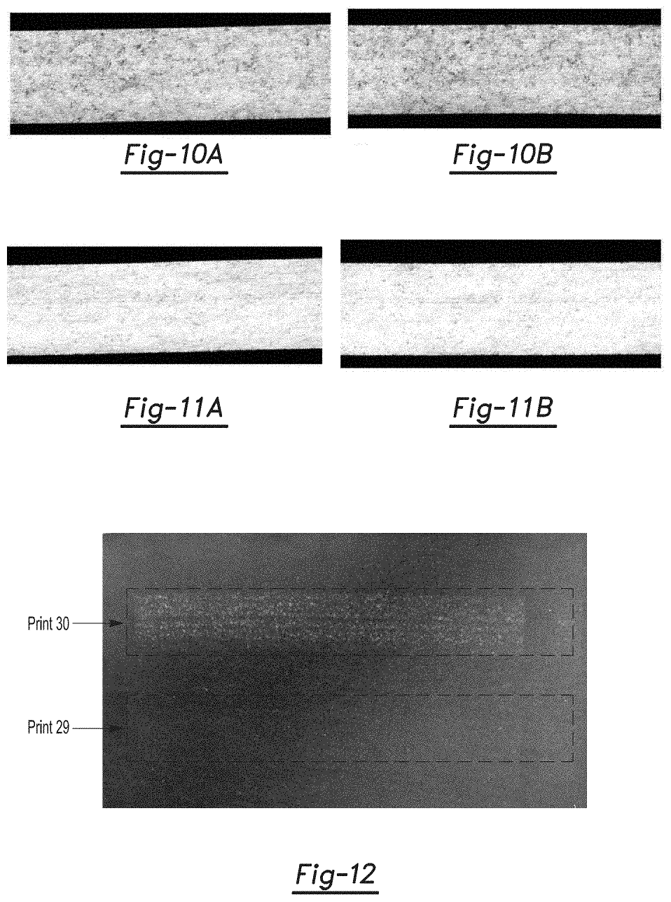

Photographs of Comp. Print 27 and Ex. Print 28 were taken before washing and after the 5 washes. These photographs are reproduced herein in black and white in FIG. 10A through FIG. 11B. The images corresponded with the quantitative L* values, illustrating an improvement in opacity for the example print as compared to the comparative print. This example print was also more opaque and less prone to fading after the washfastness test.

Comparison of Print Mode

Still more prints were generated to determine the effects of the print mode when using the pre-treatment fluids (PT 3 or PT 11) described herein. Some prints (29-35) were generated without the pre-printing heat treatment, and other prints (36 and 38-40) were generated with the pre-printing heat treatment. One comparative print (37) was generated because no pre-treatment fluid was used. Gildan soft style ring spun 64000 black cotton T-shirts were used as the textile fabric.

Table 14 sets forth the pre-printing heat treatment, the fluids that were used to generate the various prints, the order in which the fluids were printed (i.e., the printing sequence), and the amount of fluid that was dispensed in each printing pass. Each of the fluids was inkjet printed using an 11 ng thermal inkjet printhead and wet-on-wet printing. The printing sequence was repeated 6 times for each example and comparative example.

TABLE 14
Print Condition and Components

| | Pre-Print | First fluid | Second fluid | Third fluid | Fourth fluid |
|---|---|---|---|---|---|
| Print | Heat | printed | printed | printed | printed |
| sample | Treatment | (gsm) | (gsm) | (gsm) | (gsm) |
| Print 29 | N/A | Fixer fluid | PT 3 | Fixer fluid | White inkjet ink |
| | | (9.16 gsm) | (50 gsm) | (9.16 gsm) | (50 gsm) |
| Print 30 | N/A | Fixer fluid | PT 3 | N/A | White inkjet ink |
| | | (9.16 gsm) | (50 gsm) | | (50 gsm) |
| Print 31 | N/A | Fixer fluid | PT 3 | N/A | White inkjet ink |
| | | (9.16 gsm) | (50 gsm) | | (50 gsm) |
| Print 32 | N/A | Fixer fluid | White inkjet ink | N/A | PT 3 |
| | | (9.16 gsm) | (50 gsm) | | (50 gsm) |
| Print 33 | N/A | Fixer fluid | PT 3 | N/A | White inkjet ink |
| | | (18.32 gsm) | (50 gsm) | | (50 gsm) |
| Print 34 | N/A | N/A | PT 11 | Fixer fluid | White inkjet ink |
| | | | (50 gsm) | (9.16 gsm) | (50 gsm) |
| Print 35 | N/A | Fixer fluid | PT 11 | N/A | White inkjet ink |
| | | (18.32 gsm) | (50 gsm) | | (50 gsm) |
| Print 36 | Heat Press | N/A | PT 11 | Fixer fluid | White inkjet ink |
| | 150° C. | | (50 gsm) | (18.32 gsm) | (50 gsm) |
| | 1 min. | | | | |
| Comp. Print 37 | Heat Press | N/A | | Fixer fluid | White inkjet ink |
| | 150° C. | | | (9.16 gsm) | (50 gsm) |
| | 1 min. | | | | |
| Print 38 | Heat Press | Fixer fluid | White inkjet ink | N/A | PT 3 |
| | 150° C. | (9.16 gsm) | (50 gsm) | | (50 gsm) |
| | 1 min. | | | | |
| Print 39 | Heat Press | Fixer fluid | PT 3 | N/A | White inkjet ink |
| | 150° C. | (9.16 gsm) | (50 gsm) | | (50 gsm) |
| | 1 min. | | | | |
| Print 40 | Heat Press | Fixer fluid | PT 3 | Fixer fluid | White inkjet ink |
| | 150° C. | (9.16 gsm) | (50 gsm) | (9.16 gsm) | (50 gsm) |
| | 1 min. | | | | |

After all of the fluids were applied, the textile fabrics were thermally cured using a heat press set at 150° C. for about 3 minutes.

Prints 29-40 were tested for opacity and washfastness as described herein. While the results are not reproduced herein, each of Prints 29-36 and 38-40 exhibited an initial L* of at least 88.6, and Comp. Print 37 exhibited an initial L* of 87.9. The lower opacity of Comp. Print 37 was likely due to the lack of pre-treatment fluid. These results indicated that PT 3 and PT 11 improved the opacity and the washfastness, regardless of the print mode.

The prints were also observed for strikethrough. Strikethrough was observed when the white print was visible through the backside of the fabric. Strikethrough occurs when the white ink penetrates deeper into the textile fabric. The strikethrough results are set forth in Table 15.

TABLE 15
Strikethrough

| Print sample | Strikethrough |
|---|---|
| Print 29 | No |
| Print 30 | Yes |
| Print 31 | Yes |
| Print 32 | Yes |
| Print 33 | Yes |
| Print 34 | Yes |
| Print 35 | Yes |
| Print 36 | No |
| Comp. Print 37 | No |
| Print 38 | Yes |
| Print 39 | Yes |
| Print 40 | No |

The results in Table 15 indicate that the print mode does affect the strikethrough. When the fixer fluid was not printed between the pre-treatment fluid and the white ink (Prints 30-33, 35, 38, and 39), strikethrough was observed. In contrast, when the fixer fluid was printed before and after the pre-treatment fluid (Prints 29 and 40), no strikethrough was observed. Additionally, when the fixer fluid was printed only after (and not before) the pre-treatment fluid (Print 34 and 36), strikethrough was not observed when the total amount of the fixer fluid was increased to the amount deposited when two fixer fluid passes were used. In all instances, the pre-treatment fluid and the fixer fluid should be deposited before the white inkjet ink.

These results indicate that the pre-treatment fluids disclosed herein should be printed between the fixer fluid, or before the fixer fluid (where the total amount is increased to what would be deposited in two separate passes).

A photograph of Prints 29 and 30 (from the front of the fabric and from the back) were taken after the 5 washes. The photograph from the back of the fabric is reproduced herein in black and white in FIG. 12, where the general outlines of the respective prints are represented by dashed lines. Strikethrough was clearly observed for Print 30, where the fixer fluid was printed before the pre-treatment fluid on the front side of the fabric. Strikethrough was not observed for Print 29, where the fixer fluid was printed both before and after the pre-treatment fluid on the front side of the fabric.

### Example 2

This example was performed to determine whether the polymeric binder of the pre-treatment fluid could be added to the white inkjet ink, as this would even further simplify the pen configuration in the inkjet printer and the print workflow. As such, the white inkjet ink of Table 5 was prepared with twice the amount of Binder A (increased from 10 wt % to 20 wt %). The viscosity of the white inkjet ink (of Table 3) was 5.1 cP and the viscosity of the white inkjet ink with double the amount of binder A was 11.7 cP. The viscosities were measured using a VISCOLITE™ viscometer at 25° C. and 3000 Hz. Printing of the white inkjet ink with double the amount of binder A was attempted with a thermal inkjet printer, and the ink was not jettable.

It is to be understood that the ranges provided herein include the stated range and any value or sub-range within the stated range, as if the value(s) or sub-range(s) within the stated range were explicitly recited. For example, a range from about 1 wt % active to about 20 wt % active, should be interpreted to include not only the explicitly recited limits of from about 1 wt % active to about 20 wt % active, but also to include individual values, such as about 2.15 wt % active, about 6.5 wt % active, 12.0 wt % active, 15.77 wt % active, 18 wt % active, 19.33 wt % active, etc., and sub-ranges, such as from about 5 wt % active to about 15 wt % active, from about 3 wt % active to about 17 wt % active, from about 10 wt % active to about 20 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet fluid set, comprising:
a colorless pre-treatment fluid including:
a first polymeric binder selected from the group consisting of an acrylic copolymer, an acrylamide copolymer, a polyester-polyurethane, and a polyether-polyurethane; and
a pre-treatment vehicle;
a colorless fixer fluid including:
a cationic polymer; and
a fixer vehicle; and
a white inkjet ink including:
a white pigment;
a second polymeric binder; and
an ink vehicle.

2. The inkjet fluid set as defined in claim 1, wherein the first polymeric binder in the colorless pre-treatment fluid includes the polyester-polyurethane, and wherein the polyester-polyurethane is an aliphatic chain including sulfonate groups without carboxylate groups.

3. The inkjet fluid set as defined in claim 2, wherein the pre-treatment vehicle consists of:
water; or
water and a non-ionic or anionic surfactant; or
water, a co-solvent, the non-ionic or anionic surfactant, an anti-microbial agent, and an anti-decel agent.

4. The inkjet fluid set as defined in claim 1, wherein the first polymeric binder in the colorless pre-treatment fluid includes the polyester-polyurethane, and wherein the polyester-polyurethane includes sulfonate groups and an aromatic moiety.

5. The inkjet fluid set as defined in claim 4, wherein the pre-treatment vehicle consists of:
water and a non-ionic or anionic surfactant; or
water, a co-solvent, the non-ionic or anionic surfactant, an anti-microbial agent, and an anti-decel agent.

6. The inkjet fluid set as defined in claim 1, wherein the first polymeric binder in the colorless pre-treatment fluid includes the polyether-polyurethane; and wherein the polyether-polyurethane is an anionic, aliphatic chain.

7. The inkjet fluid set as defined in claim 6, wherein the pre-treatment vehicle consists of:
water and a non-ionic or anionic surfactant; or
water, a co-solvent, the non-ionic or anionic surfactant, an anti-microbial agent, and an anti-decel agent.

8. The inkjet fluid set as defined in claim 1, wherein the cationic polymer is selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; poly(dimethylamine-co-epichlorohydrin); a polyethylenimine; a polyamide epichlorohydrin resin; a polyamine epichlorohydrin resin; and a combination thereof.

9. A kit for textile printing, comprising:
a textile fabric selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof;
a colorless pre-treatment fluid consisting of:
a first polymeric binder selected from the group consisting of an acrylic copolymer, an acrylamide copolymer, a polyester-polyurethane, and a polyether-polyurethane; and
a pre-treatment vehicle;
a colorless fixer fluid consisting of:
a cationic polymer; and
a fixer vehicle; and
a white inkjet ink including:
a white pigment;
a second polymeric binder; and
an ink vehicle.

10. The kit as defined in claim 9, wherein one of:
i) the first polymeric binder in the colorless pre-treatment fluid includes the polyester-polyurethane;
the polyester-polyurethane is an aliphatic chain including sulfonate groups without carboxylate groups; and
the pre-treatment vehicle consists of:
water; or
water and a non-ionic or anionic surfactant; or
water, a co-solvent, the non-ionic or anionic surfactant, an anti-microbial agent, and an anti-decel agent; or
ii) the first polymeric binder in the colorless pre-treatment fluid includes the polyester-polyurethane;
the polyester-polyurethane includes sulfonate groups and an aromatic moiety; and
the pre-treatment vehicle consists of:
water and a non-ionic or anionic surfactant; or
water, a co-solvent, the non-ionic or anionic surfactant, an anti-microbial agent, and an anti-decel agent; or
iii) the first polymeric binder in the colorless pre-treatment fluid includes the polyether-polyurethane;
the polyester-polyurethane is an anionic, aliphatic chain; and
the pre-treatment vehicle consists of:
water and a non-ionic or anionic surfactant; or
water, a co-solvent, the non-ionic or anionic surfactant, an anti-microbial agent, and an anti-decel agent.

11. A method, comprising:
inkjet printing a colorless pre-treatment fluid on a textile fabric, the colorless pre-treatment fluid including:
a first polymeric binder selected from the group consisting of an acrylic copolymer, an acrylamide copolymer, a polyester-polyurethane, and a polyether-polyurethane; and
a pre-treatment vehicle;
inkjet printing a colorless fixer fluid on the colorless pre-treatment fluid, thereby forming a mixed fluid layer on the textile fabric, the colorless fixer composition including:
a cationic polymer; and
a fixer vehicle;
inkjet printing a white inkjet ink on the mixed fluid layer, the white inkjet ink including:
a white pigment;
a second polymeric binder; and
an ink vehicle; and
thermally curing the textile fabric having the mixed fluid layer and the white inkjet ink thereon, thereby generating a print.

12. The method as defined in claim 11, wherein the mixed fluid layer has a viscosity that is higher than a viscosity of the colorless pre-treatment fluid and a viscosity of the colorless fixer fluid.

13. The method as defined in claim 11, further comprising inkjet printing a first layer of the colorless fixer fluid on the textile fabric before inkjet printing the colorless pre-treatment fluid.

14. The method as defined in claim 13, wherein:
the inkjet printing of the first layer of the colorless fixer fluid, the inkjet printing of the colorless pre-treatment fluid, the inkjet printing of the colorless fixer fluid, and the inkjet printing of the white inkjet ink is a print cycle; and
the print cycle is repeated a predetermined number of times before thermal curing.

15. The method as defined in claim 11, wherein:
the inkjet printing of the colorless pre-treatment fluid, the inkjet printing of the colorless fixer fluid, and the inkjet printing of the white inkjet ink is a print cycle; and
the print cycle is repeated a predetermined number of times before thermal curing.
